(19) United States
(12) Patent Application Publication
(10) Pub. No.: US 2026/0187804 A1
(43) Pub. Date: Jul. 2, 2026

(54) ANGIOGRAPHY SURVEILLANCE SYSTEM AND METHOD

(71) Applicant: Sheba Impact Ltd., Ramat-Gan (IL)

(72) Inventors: Abigail LIVNY-EZER, Tel-Aviv (IL); Gal YANIV, Ramat Gan (IL)

(73) Assignee: Sheba Impact Ltd., Ramat-Gan (IL)

(21) Appl. No.: 19/131,242

(22) PCT Filed: Nov. 20, 2023
(86) PCT No.: PCT/IL2023/051196

§ 371 Date: May 20, 2025

Related U.S. Application Data
(60) Provisional application No. 63/426,756, filed on Nov. 20, 2022.

(51) Int. Cl. G06T 7/00; G06T 7/11; G06T 7/73; G06T 7/90; G06T 11/26

(52) U.S. Cl. CPC G06T 7/0016; G06T 7/11; G06T 7/74; G06T 7/90; G06T 11/26; G06T 2207/10016; G06T 2207/10024; G06T 2207/10064; G06T 2207/20081; G06T 2207/20216; G06T 2207/20221; G06T 2207/30104

(57) ABSTRACT

There is provided a computer implemented method, comprising: in a plurality of iterations over a plurality of time intervals, in real-time during a catheterization procedure: accessing a plurality of time-spaced sequential images depicting blood vessels of tissue in at least one contrast state, the plurality of time-spaced sequential images captured over a time interval of the plurality of time intervals and at one or more image planes, creating an aggregated image by stacking and/or concatenating the plurality of time-spaced sequential images, feeding an input image comprising the aggregated image into at least one ML model, and over successive time intervals, monitoring outcome of the at least one ML model for an adverse event that developed in real-time during the catheterization procedure, the outcome including a label indicating a location of at least one blood vessel in which the adverse event occurred.

### RELATED APPLICATION

This application claims the benefit of priority of U.S. Provisional Ser. No. 63/426,756 filed on Nov. 20, 2022, the contents of which are incorporated herein by reference in their entirety.

### BACKGROUND

The present invention, in some embodiments thereof, relates to machine learning models and, more specifically, but not exclusively, to machine learning models for analysis of angiography images.

Angiographic images depict blood flow through blood vessels. The angiographic images are analyzed to help identify which blood vessels are blocked, to direct treatment for opening the appropriate blood vessel to re-establish blood flow. Early intervention, for example, in ischemic stroke, may save the brain tissue downstream from the blockage.

### SUMMARY

According to a first aspect, a computer implemented method, comprises: in a plurality of iterations over a plurality of time intervals, in real-time during a catheterization procedure: accessing a plurality of time-spaced sequential images depicting blood vessels of tissue in at least one contrast state, the plurality of time-spaced sequential images captured over a time interval of the plurality of time intervals and at one or more image planes, creating an aggregated image by stacking and/or concatenating the plurality of time-spaced sequential images, feeding an input image comprising the aggregated image into at least one ML model, and over successive time intervals, monitoring outcome of the at least one ML model for an adverse event that developed in real-time during the catheterization procedure, the outcome including a label indicating a location of at least one blood vessel in which the adverse event occurred.

According to a second aspect, a computer implemented method of training a ML model for identifying an occlusion of at least one blood vessel in an input image, comprises: creating a first image of a record by: accessing a first plurality of time-spaced sequential images depicting blood vessels of the tissue in at least one contrast state, the first plurality of time-spaced sequential images captured over a time interval in which at least one occlusion is depicted, and creating a first aggregated image by stacking the first plurality of time-spaced sequential images, wherein the first image comprises the first aggregated image, creating a corresponding image of the record by: accessing a second plurality of time-spaced sequential images depicting blood vessels of the tissue in at least one contrast state, the second plurality of time-spaced sequential images captured over a time interval wherein the at least one occlusion of the first image is opened, and creating a second aggregated image by stacking the second plurality of time-spaced sequential images, wherein the corresponding image comprises the second aggregated image, and creating a training dataset comprising a plurality of records of a plurality of subject, each record including a pair of training images including the first image depicting tissue of a subject including at least one occluded blood vessel and the corresponding image depicting the tissue of the subject wherein the at least one occluded blood vessel of the first image is non-occluded, and training the ML model on the training dataset.

According to a third aspect, a computer implemented method of training a reconstruction ML model for identifying an occlusion of at least one blood vessel in an input image, comprises: creating a training dataset comprising a plurality of records of a plurality of subject, each record including a first image depicting tissue of a subject including at least one occluded blood vessel and ground truth label of a corresponding image depicting the tissue of the subject wherein the at least one occluded blood vessel of the first image is non-occluded, and training the reconstruction ML model on the training dataset for generating a reconstructed image depicting opening of at least one occlusion in response to an input of the first image depicting the at least one occlusion, wherein the reconstruction ML model is trained by inputting the first image and propagating back a difference score between the outcome of the reconstruction ML model and the corresponding ground truth of the corresponding image.

According to a fourth aspect, a computer implemented method of training an anomaly ML model for identifying an occlusion of at least one blood vessel in an input image, comprises: creating a training dataset comprising a plurality of records of a plurality of subjects, each record including a first image depicting tissue of a subject including at least one occluded blood vessel, to which at least one mask is iteratively applied to different regions of the first image, and a ground truth label of a corresponding image depicting the tissue of the subject where the at least one occluded blood vessel of the first image is non-occluded, and training the anomaly ML model on the training dataset.

In a further implementation form of any one of the first, second, third, and fourth aspects, the adverse event is selected from: occlusion, dissection, and bleeding.

further comprising computing a navigation route from a selected location in a selected blood vessel to a location of the vessel in which the identified adverse event occurred.

In a further implementation form of the first aspect, further comprising registering the input image and/or an anatomical image of the plurality of time-spaced sequential images of the aggregated image in which the adverse event was identified with a reference image indicating function of tissue, and determining function likely impacted by the adverse event of the identified vessel by mapping the location of the adverse event of the image to the reference image.

In a further implementation form of any one of the first, second, third, and fourth aspects, the at least one contrast state includes during which the plurality of time-spaced sequential images are captured include: arterial phase, parenchyma phase, and venous phase.

In a further implementation form of any one of the first, second, third, and fourth aspects, the plurality of time-spaced sequential images include images sampled from frames of a video captured during each of the arterial phase, parenchyma phase, and venous phase.

In a further implementation form of any one of the first, second, third, and fourth aspects, the at least one contrast state comprises a plurality of contrast states, wherein the plurality of time-spaced images include at least one representative image sampled from each of a plurality of contrast states, wherein creating comprises creating the aggregated image by concatenating and/or stacking the at least one representative image sampled from each of a plurality of contrast states for creating a multi-channel image, wherein the input image comprises the multi-channel image.

In a further implementation form of any one of the first, second, third, and fourth aspects, the plurality of time-spaced sequential images are captured over a plurality of different image planes defined by different orientations of an image sensor, wherein the plurality of time-spaced images include at least one representative image sampled from each of the plurality of different image planes, wherein creating comprises creating the aggregated image by concatenating and/or stacking the at least one representative image sampled from each of the plurality of different image planes for creating a multi-channel image, wherein the input image comprises the multi-channel image.

In a further implementation form of any one of the first, second, third, and fourth aspects, selecting at least two consecutive images of the plurality of time-spaced sequential images, wherein creating comprises creating the aggregated image by concatenating and/or stacking the at least two consecutive images for creating a multi-dimensional image, wherein the input image comprises the multi-dimensional image.

In a further implementation form of any one of the first, second, third, and fourth aspects, further comprising selecting at least two consecutive images of the plurality of time-spaced sequential images, wherein creating comprises segmenting each of the at least two consecutive images to obtain at least two segmented images, and averaging the at least two segmented images to obtain a single averaged segmented image, wherein the input image comprises the single averaged segmented image.

In a further implementation form of the first aspect, the ML model is trained on a training dataset comprising a plurality of records of a plurality of subject, each record including a pair of training images including a first image depicting tissue of a subject including at least one occluded blood vessel and a second image depicting the tissue of the subject wherein the at least one occluded blood vessel of the first image is non-occluded, wherein the first image and the corresponding image of each record comprise a respective aggregated image created by concatenating and/or stacking time-spaced sequential images.

In a further implementation form of the first aspect, further comprising applying an interpretability model to the at least one ML model for computing contribution of single pixels or groups of pixels of the input image towards the outcome, and generating a heatmap indicating locations likely depicting at least one occluded blood vessel by visually representing the contribution of pixels of the input image.

In a further implementation form of the first aspect, the at least one ML model comprises a reconstruction ML model, and wherein feeding comprises feeding the input image into the reconstruction ML model, and further comprising: obtaining a reconstructed image as an outcome of the reconstruction ML model, computing a difference score between the reconstructed image and the input image, and identifying an occlusion of the at least one blood vessel when the difference score is above a threshold, wherein the reconstruction ML model is trained on a training dataset comprising a training dataset comprising a plurality of records of a plurality of subject, each record including a first image depicting tissue of a subject including at least one occluded blood vessel and ground truth label of a corresponding image depicting the tissue wherein the at least one occluded blood vessel of the first image is non-occluded.

In a further implementation form of the first aspect, the first image and the corresponding image of each record comprise a respective aggregated image created by concatenating and/or stacking time-spaced sequential images.

In a further implementation form of the first aspect, further comprising computing the difference score for each of a plurality of regions of the input image, and identifying a location of the occlusion at a certain region when the difference score for the certain region is above the threshold.

In a further implementation form of the first aspect, further comprising generating a heatmap by visually representing different scores for the plurality of regions.

In a further implementation form of the first aspect, the at least one ML model comprises an anomaly ML model, and further comprising for each input image generated for each iteration of the plurality of iterations: applying at least one mask to at least one region of the input image into the anomaly ML model, wherein feeding comprises feeding the input image with applied at least one mask into the anomaly ML model, obtaining a reconstruction of the input image including at least one region corresponding to the at least one region of the input image to which the at least one mask is applied, computing a difference score between the at least one region of the reconstructed image and the corresponding at least one region of the input image without the applied at least one mask, wherein in each iteration the at least one mask is applied to a different at least one region of the input image, and identifying the location of the occlusion of the at least one blood vessel as a region corresponding to the at least one region when the difference score is above a threshold and/or for the at least one region having highest difference score.

In a further implementation form of the first aspect, the anomaly ML model is trained on a training dataset comprising a plurality of records of a plurality of subjects, each record including a first image depicting tissue of a subject including at least one occluded blood vessel, to which at least one mask is iteratively applied to different regions of the first image, and a ground truth label of a corresponding image depicting the tissue of the subject where the at least one occluded blood vessel of the first image is non-occluded.

In a further implementation form of any one of the first, second, third, and fourth aspects, the first image and the corresponding image of each record comprise a respective aggregated image created by concatenating and/or stacking time-spaced sequential images.

In a further implementation form of the first aspect, the iterations are performed for applying the at least one mask for covering the tissue of the input image.

In a further implementation form of the first aspect, further comprising quantifying the input image into a plurality of colors, wherein the images in the training dataset are quantified into a plurality of colors.

In a further implementation form of any one of the first, second, third, and fourth aspects, wherein the tissue is selected from: brain, heart, lungs, liver, and digestive system, the input image is an angiographic image with contrast introduced into vasculature and the at least one blood vessel comprises a blood vessel of the at least one of: brain, heart, lungs, liver, and digestive system.

In a further implementation form of any one of the first, second, third, and fourth aspects, the aggregated image includes a plurality of colors, each color denoting a different contrast phase.

In a further implementation form of any one of the first, second, third, and fourth aspects, the adverse event comprises occlusion of a blood vessel, and further comprising treating the subject by opening the identified occluded vessel.

In a further implementation form of any one of the first, second, third, and fourth aspects, the treatment for opening the identified occluded vessel comprises mechanical removal of an embolism and/or injection of an agent for dissolving the embolism.

In a further implementation form of the third aspect, the difference score comprises a L2 difference score.

In a further implementation form of the third aspect, the difference is computed by convolving the input image and the reconstructed image with a filter.

In a further implementation form of the third aspect, the filter comprises a mean filter that computes the mean of each square of a fixed size for the reconstructed image and for the input image, and computing the difference score for each square.

In a further implementation form of the third aspect, further comprising iterating the computing the mean for each square of a plurality of squares that cover the input image and the reconstructed image, wherein the occlusion is identified as one or more squares with the difference score greater than a threshold and/or a number of squares with highest difference scores.

In a further implementation form of the fourth aspect, the iterations are performed for applying the at least one mask for covering the tissue of the input image.

In a further implementation form of the fourth aspect, further comprising quantifying the input image into a plurality of colors, wherein the images in the training dataset are quantified into a plurality of colors.

In a further implementation form of the fourth aspect, the plurality of colors comprises 7.

In a further implementation form of the fourth aspect, the at least one mask is not applied to the post-procedure image serving as ground truth.

In a further implementation form of the fourth aspect, the anomaly ML model is trained by inputting the image with applied at least one mask and propagating back a L2 difference between the outcome of the anomaly ML model for the at least one region corresponding to the applied at least one mask and the corresponding image that excluded the applied at least one mask.

In a further implementation form of the fourth aspect, the mask is square.

In a further implementation form of the fourth aspect, further comprising: creating the first image of the record by: accessing a first plurality of time-spaced sequential images depicting blood vessels of the tissue in at least one contrast state, the first plurality of time-spaced sequential images captured over a time interval in which the at least one occlusion is depicted, and creating a first aggregated image by stacking the first plurality of time-spaced sequential images, wherein the first image comprises the first aggregated image, and creating the corresponding image of the record by: accessing a second plurality of time-spaced sequential images depicting blood vessels of the tissue in at least one contrast state, the second plurality of time-spaced sequential images captured over a time interval wherein the at least one occlusion of the first image is opened, and creating a second aggregated image by stacking the second plurality of time-spaced sequential images, wherein the corresponding image comprises the second aggregated image.

In a further implementation form of any of the preceding aspects, the plurality of time-spaced sequential images include 2D fluoroscopy images captured in real-time during the catheterization procedure.

In a further implementation form of any of the preceding aspects, the at least one ML model is trained using transfer learning and/or domain shift approaches, on at least one other pre-trained ML model which was trained on other sample images including other diagnostic images and/or images depicting adverse events.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system for identifying an adverse event of at least one blood vessel in an image, in accordance with some embodiments of the prevent invention;

FIG. 2 is a flowchart of a method of identifying an adverse event of at least one blood vessel in an image, in accordance with some embodiments of the prevent invention;

FIG. 3A is a flowchart of a method of training a ML model for identifying an adverse event of at least one blood vessel in an image, in accordance with some embodiments of the prevent invention;

FIG. 3B is a flowchart of a method of training a reconstruction ML model for identifying an adverse event of at least one blood vessel in an image, in accordance with some embodiments of the prevent invention;

FIG. 3C is a flowchart of a method of training an anomaly ML model for identifying an adverse event of at least one blood vessel in an image, in accordance with some embodiments of the prevent invention;

FIG. 4A is a flowchart of a method of inference by the ML model for identification of the adverse event, in accordance with some embodiments of the prevent invention;

FIG. 4B is a flowchart of a method of inference by the reconstruction ML model, in accordance with some embodiments of the prevent invention;

FIG. 4C is a flowchart of a method of inference by the anomaly ML model, in accordance with some embodiments of the prevent invention;

FIG. 5 is an image of a cerebral vascular tree in which an occluded vessel has been identified post procedure, to help understand some embodiments;

FIG. 6 is another image of a cerebral vascular tree in which an occluded vessel has been identified in a zoom-in field of view, to help understand some embodiments;

FIG. 7 is a 3 channel image, where each one of the three colors represents a different contrast phase, in accordance with some embodiments of the present invention

FIG. 8 is an image of a brain indicating an example of a correlation between an occlusion detected during a catheterization procedure and functionality of the region of the brain impacted by the occluded vessel, in accordance with some embodiments of the present invention;

FIG. 9 is a schematic depicting an example of a map of brain vasculature generated per subject being treated, designed for navigation (e.g., optimal navigation) to the different vessels along the vasculature tree, in accordance with some embodiments of the present invention;

FIG. 10 includes examples of training images and test images of the reconstruction ML model, in accordance with some embodiments of the present invention

FIG. 11 is a schematic depicting an exemplary ML model for classifying an input image as occluded or non-occluded (e.g., healthy) and a heatmap, in accordance with some embodiments of the present invention;

FIG. 12 includes examples of input images fed into the ML model for classification of input images and a heatmap outcome generated based on the ML model, in accordance with some embodiments of the present invention;

FIG. 13 is a schematic of an exemplary ML model for reconstructing a non-occluded image of an input occluded image, in accordance with some embodiments of the present invention;

FIG. 14 is a schematic of an exemplary process for reconstruction of an unmasked image using the trained anomaly ML model, in accordance with some embodiments of the present invention;

FIG. 15 depicts an example of an image with occluded vessel (left pane) and example output generated by the anomaly ML model, where square masked regions with high difference scores are marked, in accordance with some embodiments of the present invention;

FIG. 16 includes examples of the first type of image selected in pre-processing, in accordance with some embodiments of the present invention;

FIG. 17 includes examples of the second type of aggregated image computed in pre-processing, in accordance with some embodiments of the present invention;

FIG. 18 includes an example of the third type of aggregated image computed in pre-processing, in accordance with some embodiments of the present invention;

FIG. 19 includes an example of the fourth type of aggregated image computed in pre-processing, in accordance with some embodiments of the present invention;

FIG. 20 includes an example of the fifth type of aggregated image computed in pre-processing, in accordance with some embodiments of the present invention;

FIG. 21 depicts further processing based on the averaged segmented image of FIG. 20, in accordance with some embodiments of the present invention.

### DETAILED DESCRIPTION

The present invention, in some embodiments thereof, relates to machine learning models and, more specifically, but not exclusively, to machine learning models for analysis of angiography images.

As used herein, the terms “neuro-endovascular procedure”, “catheterization procedure” “procedure”, and the like, are exemplary, and not necessarily limiting. As used herein, references to the brain (i.e., blood vessels of the brain) are meant to be exemplary and not necessarily limiting. It is to be understood that embodiments described herein may be used for analyzing images (e.g., fluoroscopy) of different parts of the body, for example, brain vasculature, coronary vessels, blood vessels of the lungs, blood vessels within the liver, blood vessels of the limbs (e.g., arms, legs), blood vessels of the digestive system (e.g., stomach, large intestine, small intestine) and the like. The images are captured during endovascular procedures, for example, angiography (i.e., imaging of the blood vessels), opening occluded blood vessels, treating bleeding from blood vessels, for treating a dissection, and the like.

As used herein, the term “occlusion” may sometimes (where relevant) refer to another not necessarily limiting example of an “adverse event”. The term occlusion may sometimes (where relevant) be substituted with the term adverse event, or may be substituted with another example of the adverse event, such as bleeding and/or dissection and/or other injury. ML models described herein for analyzing images may be implemented using different architectures suitable to perform the task described herein, and/or for being trained as described herein. The architecture of the ML model(s) may vary according to whether the ML model is trained using a supervised approach of a non-supervised approach. For example, neural networks such as conventional neural networks (CNN), recurrent neural networks (RNN), and the like. Architectures depicted in the figures are meant to be exemplary and not limiting.

As used herein, the term “first image” refers to an image of blood vessels in which an adverse event occurred in one or more of the blood vessels, for example, an occlusion. The term “corresponding image” refers to an image of blood vessels in which no adverse event is depicted, for example, a non-occluded vessel. The corresponding image may depict the same blood vessels as the first image, where no adverse event is present. For example, the occlusion in a vessel shown in the first image has been opened. The opened vessel (i.e., non-occluded vessel) is shown in the corresponding image.

The “first image” and the “corresponding image” may be 2D images, optionally 2D fluoroscopy images captured during angiography and/or other intra-vascular catheterization procedure.

Embodiments described herein with respect to detection of occlusion may be adapted to detect other adverse events. For example, substituting images depicting another adverse event for images depicting occlusion.

As used herein, the term “adverse event” may refer to an injury that was not caused by medical error or surgical treatment (e.g., bleeding due to weakened vessel wall, embolism due to coagulation state of patient's blood and/or presence of plaques in the blood vessels of the patient), and/or may refer to injury that was caused by medical error and/or surgical treatment (e.g., release of plaque due to manipulation of catheter in the blood vessel, increased bleeding due to improper administration of blood anticoagulant, perforation of a blood vessel due to manipulation of a catheter within the blood vessel).

As used herein, the feature of identifying a location of an adverse event of a blood vessel may refer to generating a bounding box (or other bordering shape) encompassing the location within the blood vessel where the adverse event is detected, marking the location by an overlay (e.g., color coded, pointing arrow) and/or generating a heatmap that indicates likelihood of the location of the blood vessel where the adverse event is detected.

As used herein, the term “image plane” refers to the a certain orientation and/or view of an image sensor capturing the image (e.g., fluoroscopy image). For example, during angiography, a C-arm of an imaging device may be moved to different orientations to capture images at different image planes, such as anterior-posterior (AP) plane, and/or a lateral plane.

As used herein, the term “real-time” may be interchanged with the term “near real-time”. “Real-time” refers to the processing of images (or video frames) with minimal delay, allowing for immediate or near-immediate analysis and response. The processing of the aggregated image by the ML model in real-time may refer to completing the processing of a current aggregated image prior to completion of computation of the next aggregated image for readiness to be fed into the ML model.

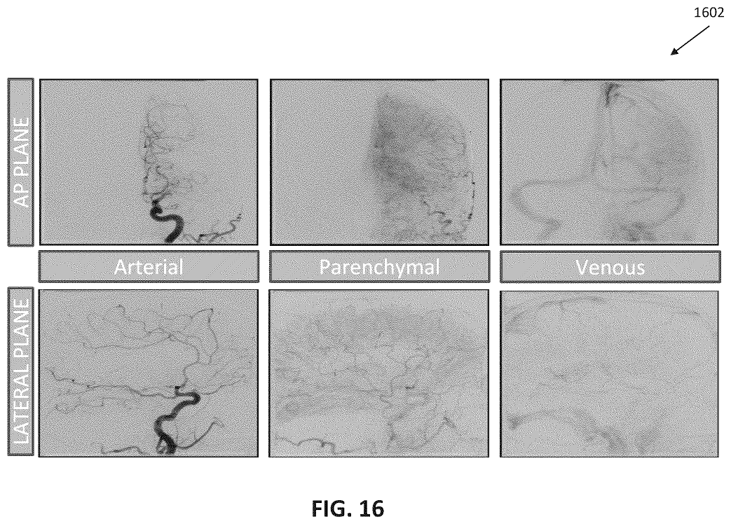

As used herein, the term “input image” which is fed into the ML model(s) may refer to, and/or may be interchanged with the term “aggregated image” which is computed as described herein, for example, described with respect to FIGS. 16-20 and/or other examples described herein. In some embodiments, the “input image” may refer to a DSA image.

As used herein, the term “reference image” may refer to, for example, an atlas image and/or any structural and/or any functional scan such as a functional MRI scan, from which functionality may be deduced.

As used herein, the term “anatomical image” may refer to, for example, a single image (optionally selected from the time-spaced sequential images, optionally used to generate the aggregated image in which the adverse event was identified), to multiple time-spaced sequential images, to the “aggregated image” (e.g., used to detect the adverse event), and/or to the “input image”. The anatomical image may be registered to the functional image and/or may be used for computing the navigation route, as described herein.

An aspect of some embodiments of the present invention relates to systems, methods, computing devices, and/or code instructions (stored on a data storage device and executable by one or more hardware processors) for real-time monitoring for adverse events during a catheterization procedure. An aggregated image may be created, by concatenating and/or stacking time-spaced sequential images obtained in real-time over a time interval depicting one or more contrast states and/or one or more image planes, optionally fluoroscopy images. A respective aggregated image may be created for each successive time interval, and fed in real-time into one or more ML models described herein. Outcome of the ML model(s) may be monitored over successive time intervals for detecting the adverse event that developed in real-time during the catheterization procedure. The outcome may include an identified location of a vessel in which the adverse event occurred. For example, an overlay is generated over the location of the vessel in which the adverse event occurred depicted one or more of the time-spaced sequential images and/or over the aggregated image. The indication (e.g., overlay) may include a color coding of the location, an arrow pointing to the location, a bounding box, a heatmap, and the like. In another example, coordinates (e.g., of pixels) indicating the location of the vessel in which the adverse event occurred may be computed and provided.

Optionally, an anatomical image may be registered with a reference image indicating function of tissue, for example, of the brain.

Function likely impacted by the adverse event of the identified vessel may be determined by mapping the location of the adverse event of the image to the reference image.

Alternatively or additionally, a navigation route from a selected location in a selected blood vessel to the location of the vessel in which the adverse event occurred is computed, and optionally presented, for example, as an overlay over the anatomical image.

It is noted that the aggregated image computed by stacking and/or concatenating as described herein, excludes the subtraction of images, for example, the aggregation images is not generated based on digital subtraction angiography (DSA). DSA commonly involves the administration of a contrast agent while simultaneously capturing a sequence of successive fluoroscopy images, with the first shot image, serving as the mask, being digitally subtracted from all other images of the sequence. However, the aggregated image which is fed into the ML model(s) may be computed by stacking and/or concatenating the sequence of the digitally subtracted images computed using individual DSA images, which is different than feeding individual digitally subtracted images into a machine learning model. As described herein, sequentially feeding individual DSA obtained in real-time into a machine learning model (trained to analyze individual DSA images) is much less efficient (e.g., in terms of long processing time of a computer, heavy use of processing resources and/or memory) than feeding the aggregated image into the ML model described herein (which enables real-time processing and/or provides improved efficiency of the computer running the ML model, as described herein).

The feature of registration of the single image, optionally a 2D fluoroscopy image, with the reference image to determine function (e.g., brain function) likely impacted by the adverse event, is different than standard approaches for determining function (e.g., brain function) likely impacted by the adverse event, for example, clinical evaluation of function by a neurologist (e.g., clinically evaluating motor, speech, memory, and the like) and/or inspection of a 3D CT angiography image of the brain.

The feature of automatically computing the navigation route using the anatomical image, such as to navigate from a selected location to the location of the adverse event, may improve clinical outcomes for the patient, for example, by quickly selecting the navigation route using an existing image and identified location(s). The automatically computed navigation route is in contrast, for example, to standard approaches such as manual determination of the navigation route by the operator, which may lead to errors in navigation and/or delay in providing treatment.

An aspect of some embodiments of the present invention relates to systems, methods, computing devices, and/or code instructions (stored on a data storage device and executable by one or more hardware processors) for automated monitoring of images of blood vessels (e.g., angiographic images) for detection of one or more adverse events (e.g., vessel occlusion), which may occur during any diagnostic and/or interventional catheterization procedure, such as for opening another blocked vessel and/or a diagnostic angiography procedure, as a complication of procedure. The user (e.g., physician) performing the catheterization procedure may be unaware of the new blockage. At least some embodiments described herein are designed to identify new vessel blockages or other adverse events, optionally in real-time or near real-time, which enables the user to determine whether the new vessel blockage is to be treated and/or the form of treatment. Angiographic procedures may be performed, for example, in the brain, heart, and all other parts of the body where procedures are performed to open occlusions, for example, via stent deployment and/or capture of emboli. The automated detection may be performed by one or more machine learning models analyzing images depicting blood vessels captured during the procedure (e.g., 2D fluoroscopy images), optionally iteratively in real-time to monitor for new adverse events occurring during the procedure. The images may be pre-processed for creating an aggregated image(s) by concatenating and/or stacking time-spaced sequential images depicting the blood vessels, captured over one or more contrast states and/or at one or more orientations of an image sensor. Examples of machine learning models include one or more, or combinations, of: (i) a ML model for identification of the adverse event, optionally by classifying an input angiographic image into depicting one or more blocked vessels or not depicting blocked vessels, where a heatmap may be generated by applying an interpretability model to determine location of the blocked vessel (ii) a reconstruction ML model that is fed an input of an angiographic image depicting blood flow blocked by one or more vessels, generates a reconstruction of the image depicting blood flow that is non-blocked, and identifies a location of the vessel based on the difference between the images, and (iii) an anomaly ML model that operates similarly to the reconstruction ML model, with iterative applications of a mask to different regions of the input angiographic image for reconstruction of the masked region and identifies a location of the vessel based on the difference between the regions of the images corresponding to the mask. The machine learning model may be based on another pre-trained ML model which was trained on other fluoroscopy images such as other diagnostic images and/or images with parenchymal occlusion labeled-for either classification or adverse event location detection, for example, by a transfer learning approach, domain shift approach, and the like. Images captured during the procedure (e.g., x-ray angiographic images) may be fed into one or more of the ML models in real-time or near real-time, for identification of the adverse event and/or location thereof. An anatomical image for which the adverse event was identified may be registered with a reference image indicating function of tissue mapped to anatomical regions and optionally presented on a display. Tissue (e.g., brain) function likely impacted by the adverse event of the identified vessel on one or more anatomical regions may be determined by mapping the location of the adverse event of the image to the reference image. A navigation route from a selected intravascular location (e.g., existing location of a catheter) to a location of the vessel of the identified adverse event and/or to another intravascular location and/or for any purpose may be computed and presented on the display.

One or more ML models described herein may be trained using a non-supervised approach, where no label indicating the location of the blocked vessel is provided for the training images. One or more ML models learn to identify the location of the blocked vessel from pairs of images, optionally angiographic images (e.g., x-ray images of the body part in one or more contrast phases, such as venous, arterial, parenchyma) where a first image depicts a vascular tree with one or more occlusions, optionally obtained pre-procedure and a second image (e.g., corresponding image) depicts the vascular tree without the occlusions depicted in the first image, optionally after the occlusion(s) have been opened by the procedure.

Alternatively or additionally, the images of the training dataset may include one or more ground truth labels indicating locations of occluded vessels. The corresponding images with ground truth label indicating location may be used for supervised training of one or more ML models.

In some embodiments, the training dataset may include training images in which no occlusion has been opened. For example, where the procedure is diagnostic angiography, and no occlusion has been found, the first image depicting the blood vessel(s) with adverse event (e.g., blockage) is substantially the same as the corresponding image depicting the blood vessel(s) of the first image (which had the adverse event, for example, blockage) without the adverse event, for example, without blockage. The first image may be captured prior to a procedure for treating the adverse event, for example, prior to opening the blockage. The corresponding image may be captured after the procedure for treating the adverse, event for example, after the blockage has been opened.

It is to be understood that embodiments described herein are not necessarily limited to opening an occlusion and/or treatment of bleeding for a vessel. The opening of an occluded vessel and treatment of bleeding are to be understood as examples. Embodiments described herein may be used for other clinical indications, for example, for treatment and/or navigation to: arteriovenous malformation, dural arteriovenous fistulas, epistaxis, and the like.

Optionally, one or more of the ML models are trained in a non-supervised approach, without labels denoting locations of the occluded blood vessels in the training images depicting the occluded vessels.

Optionally, input images captured in real-time during a catheterization procedure are iteratively fed into one or more of the ML models for near real-time detection of an obstruction of a vessel occurring during the catheterization procedure.

Optionally, the tissue is brain, the input image is an angiographic image with contrast introduced into vasculature and the at least one blood vessel comprises a blood vessel of the brain.

Optionally, a processor correlates and/or registers a location of identified occluded vessel of the aggregated image (computed as described herein) with a reference image (e.g., CT, CT angiography, MRI, functional MRI) denoting function of anatomical regions to create a combined image. The combined image may be used for predicting and/or determining function likely impacted by the identified occluded vessel. The reference image may be, for example, a standard anatomical image (e.g., CT, CT angiography, MRI) that is registered to a functional atlas of the brain. In another example, the reference image may be a functional image of the subject, for example, a functional MRI image, and/or a PET scan and/or a PET/CT image. In yet another example, the reference image may be an atlas. Since different tissues (e.g., different parts of the brain) are fed by different blood vessels, obstruction of a certain vessel reduces blood supply to a certain anatomical region of the tissue (e.g., brain). Impacted Function (e.g., brain functionality such as movement of a limb, memory, vision, speech) may be deduced according to the anatomical region which is experiencing decreased or lack of blood supply.

Optionally, the input image is captured during a catheterization procedure, and the occlusion of the at least one blood vessel is a complication of the catheterization procedure.

Optionally, the input image comprises an aggregated image computed from a plurality of images obtained during a plurality of contrast phases, the aggregated image computing by applying a different label to each respective image obtained during a respective contrast phase, the aggregated image including a plurality of labels corresponding to the plurality of contrast phases. Optionally, each different label is a different color, and the aggregated image includes a plurality of colors, each color denoting a different contrast phase. Examples of contrast phases include: arterial phase, parenchyma phase and venous phase. In an exemplary implementation, three images depicting the three contrast phases are stacked into three channels to construct a multi-channel image, optionally a multi-color images, for example, a red-green-blue (RGB), cyan-magenta-yellow, or other color space.

Optionally, the input image comprises a plurality of input images fed into one or more of the ML model, wherein the ML model(s) combines features extracted from the plurality of images to obtain the outcome, wherein the training dataset includes a plurality of the sample images. The input images may be captured at one or more different anatomical planes, and/or captured at one or more different contrast phases.

Optionally, the subject is treated for the identified occluded vessel by opening the identified occluded vessel. The treatment for opening the identified occluded vessel may be done, for example, by one or more of: catheter removal of an embolism, catheter injection of local thrombolytic agent, and systemic administration of a thrombolytic agent.

Optionally, the processor identifies a current location of a catheter for treatment an obstructed vessel, and computing a navigation route from the current location to a location in another blood vessel for treatment of a pathological vessel.

At least some embodiments described herein address the technical problem of real-time monitoring of an adverse event (e.g., vessel occlusion, dissection, bleeding) during a catheterization procedure, optionally for treating the adverse event such as by opening another occluded vessel and/or for diagnosis. Since the vessel occlusion occurs during the catheter procedure itself, the user (e.g., physician) performing the procedure may be unaware of the real-time new occlusion, and miss opening the new occlusion. At least some embodiments described herein improve the technical field and/or medical field of neurovascular angiography, by real-time monitoring of vessel occlusions occurring during a catheterization procedure.

At least some embodiments described herein address the technical problem(s) described herein, and/or improve technology described herein, and/or improve performance of a computer analyzing images and/or executing the ML model(s), by creating an aggregated image by stacking multiple time-spaced sequential images (e.g., fluoroscopy images) captured over a time interval. The aggregated image may be a multi-dimensional image. Alternatively or additionally, the aggregated image may be a multi-channel image. The images are captured over one or more contrast states, for example, arterial, parenchyma, and venous. The images may be sampled from frames of a video captured over the one or more contrast states. The aggregated images, each of which are successively computed in real-time over respective time intervals during which fluoroscopic images are captured, are fed into a ML model(s). The outcome of the ML model(s) is monitored to detect likelihood of an adverse event occurring in real-time during the procedure and optionally to detect the location of the adverse event within a blood vessel. The computation of the aggregated image enables the ML model to operate in real-time. For example, in contrast, using standard available computational resources, the ML model may not be able to keep up with processing successively fed individual images. Since analyzing each image uses significant processing resources and/or takes a significant amount of processing time, the ML model running on standard computational hardware would likely be unable to keep up with successive images. The ML model would likely be unable to complete processing one image before the next image arrives, creating a backlog and delay in detection. In contrast, the ML model running on standard computational hardware would likely be able to keep up with successive aggregated images fed over successive time intervals (during which multiple images used to compute aggregated images are captured), enabling real-time detection of adverse events. It is noted that a single aggregated image may be computed, or multiple aggregated images may be computed, for example, according to a type of the aggregated image, as described herein. For example, in the case of multiple image planes, there may be multiple aggregated image, such as a single image per image plane.

Moreover, computing the aggregated image and feeding the aggregated image into the ML model improves utilization of the computing running the ML model, as described in the preceding paragraph.

At least some embodiments described herein improve the technology of ML models, by improving the accuracy of the ML model detecting the adverse event in real-time. Computing the aggregated image and feeding the aggregated image into the ML model may improve the accuracy of the ML model in detecting the adverse event in real-time. In tissue such as the brain, there are a large number of blood vessels that are close to one another, arranged in a complex tree structure. Contrast introduced into this vasculature tree quickly dissipates. Analyzing individual frames may be inaccurate, since distribution of the contrast throughout the vasculature tree may be inconsistent in different vessels. As such, it is difficult to determine which individual image depicts an adverse event, for example, does the image depict an obstructed vessel, or does the image show an intermediate phase in contrast distribution where the contrast has not yet reached the end of the blood vessel? The aggregated image, computed from multiple images captured during one or more contrast phases, is more likely to more accurately indicate presence of the adverse event. The aggregate image may be indicate an occlusion, for example, by indicating a location where contrast becomes “stuck” and does not continue flow across the contrast phases, such as from arterial to parenchyma to venous.

At least some embodiments described herein address the technical problem of training a machine learning model(s) for real-time detection of occlusions in medical images depicting blood vessels in one or more contrast phases. At least some embodiments described herein improve the technical field of machine learning models, by training a machine learning model(s) for real-time detection of occlusions in medical images depicting blood vessels in one or more contrast phases.

Stroke is the leading cause of disability and the fifth leading cause of death in the United States. Every year, more than 795,000 people in the United States have a stroke. Epidemiologic studies indicate that 82-92% of strokes in the United States are ischemic. During neuro-endovascular procedures (e.g., treating for strokes, aneurysms and other vascular pathologies), whether diagnostic or treatment, one of the main potential complications is distal thromboembolization with vessel occlusion. Although extremely varied in prevalence between different procedures, shown in about 0.5-7% of all procedures. Any unintended vessel occlusion in the brain may cause a stroke leading to different functional deficits according to the area nourished by the occluded vessel. The outcome then depends mostly on the area supplied by the blocked vessel, as well as the speed of which this complication is treated.

Timely detection of the occluded vessels during neuro-endovascular procedures is crucial and highly time sensitive. As time elapses, more damage is caused to the tissue and the ability for a successful recanalization treatment reduces rapidly. Moreover, real-time detection of occluded vessels, in particular in small and distal vessels, is extremely challenging since during the procedure the endovascular neurosurgeon's attention is centered on the vessel being treated, other distal vessels blockages may occur which may go unnoticed.

At least some embodiments described herein address the aforementioned technical problem(s) and/or improve the aforementioned technical field(s), by providing approaches for better performance of the neuro-endovascular procedure. At least some embodiments described herein serve as the endovascular surgeon's surveillance system to detect and/or alert when an unintended occlusion occurs. Early detection may reduce complications and/or increase the procedure's success rates.

At least some embodiments described herein relate to a fusion with functionality of the occluded vessel's brain surrounding to understand importance and/or urgency of action needed,

At least some embodiments described herein provide a navigation map of the brain vasculature designed to assist the endovascular surgeon in find an optimal path(s) to a specific vessel, for example, for optimal opening of the unintended occlusion.

At least some embodiments described herein address the aforementioned technical problem(s) and/or improve the aforementioned technical field(s), by providing an approach which will serve as the endovascular neurosurgeon “bodyguard”, or “third eye”. Embodiments described herein use medical images (e.g., x-ray, angiography) which are taken during the procedure and, in real-time, examine these images for an indication (e.g., signs, features) of likelihood of vessel occlusion, and flag the likely occlusion to the user (e.g., endovascular neurosurgeon). Optionally an alert is generated, and/or the location of the occlusion is marked on the image (e.g., color coded, bounded, arrow). Some embodiments include an additional module which for registration to previously acquired CTA and MRI scans, designed for allowing to associate the vessel to its functional regions, which may assist the endovascular neurosurgeon to recognize whether important brain structures are at risk and/or additional intervention is critical.

At least some embodiments described herein address the aforementioned technical problem(s) and/or improve the aforementioned technical field(s), by detecting brain vessels occlusions in real-time during the neuro-endovascular procedure, which may improve diagnosis, treatment decision and/or prognosis, aiming to prevent or reduce adverse events in neuro-endovascular procedures.

At least some embodiments described herein provide one or more of the following features, which provide solutions to the aforementioned technical problem(s) and/or improve the aforementioned technical field(s):
Timely alert of unwanted vessel occlusion to enable better prognosis of intra-procedural complication.

Visually indicating location of the vessel(s) in which the adverse event occurred (e.g., blockage), for example, by drawing a bounding box, generating a heatmap, an arrow pointing to the location of the adverse event, and the like. The visual indication may be, for example, an overlay over the fluoroscopy image.
Navigation map to the pathological vessel.
Comprehensive decision-making tool for the endovascular surgeon.
Creating a technological bridge for use of ML models in angiographic procedures as an assisting and/or navigation tool.
Automated analysis-No need for surgeon's intervention.
Continuous and constant alert system, for real-time monitoring of complications of embolisms in vessels occurring during a catheterization procedure.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

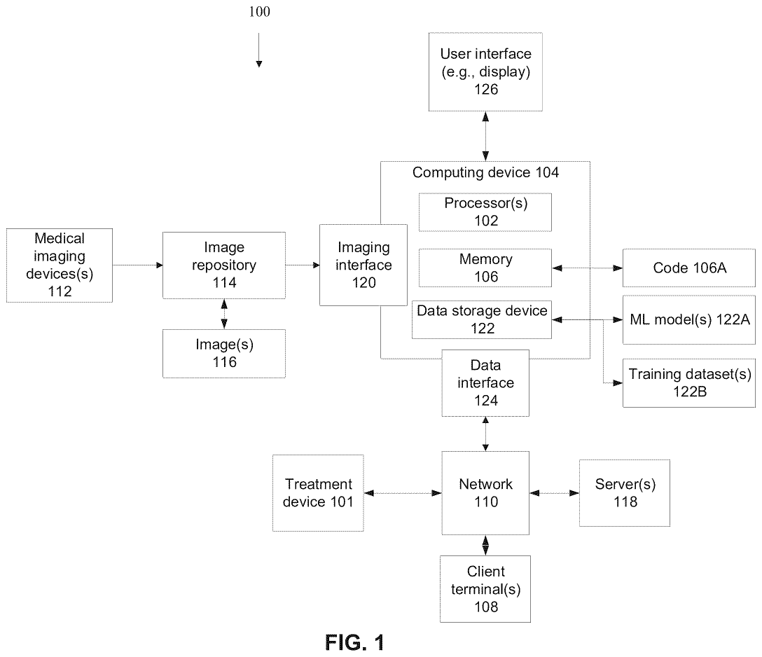

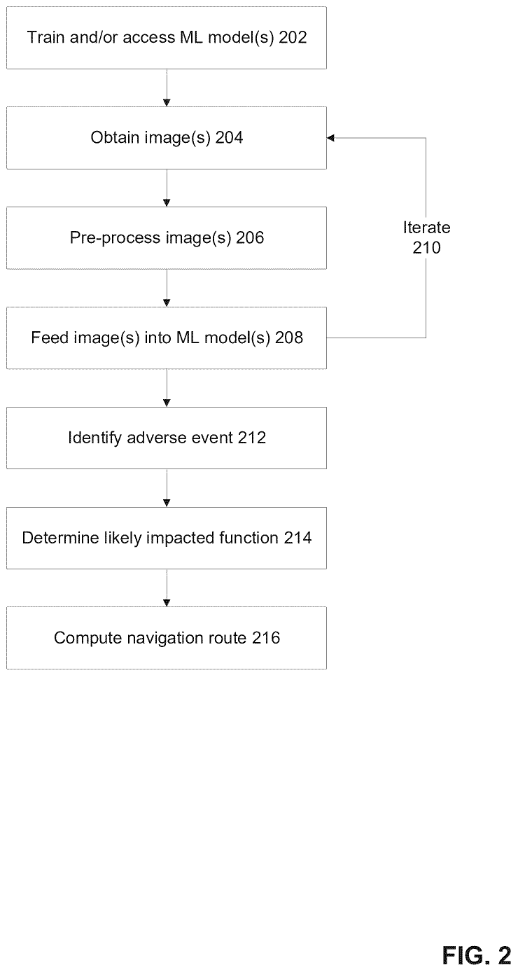

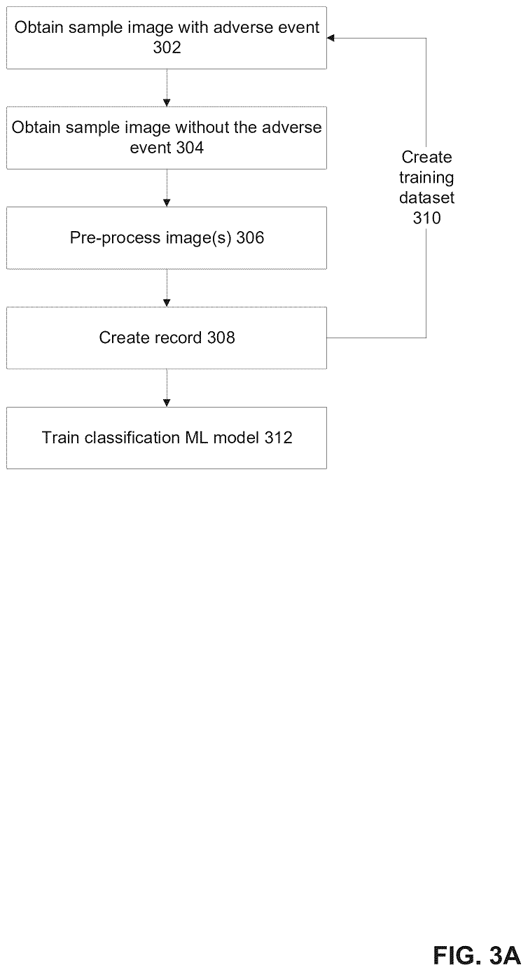

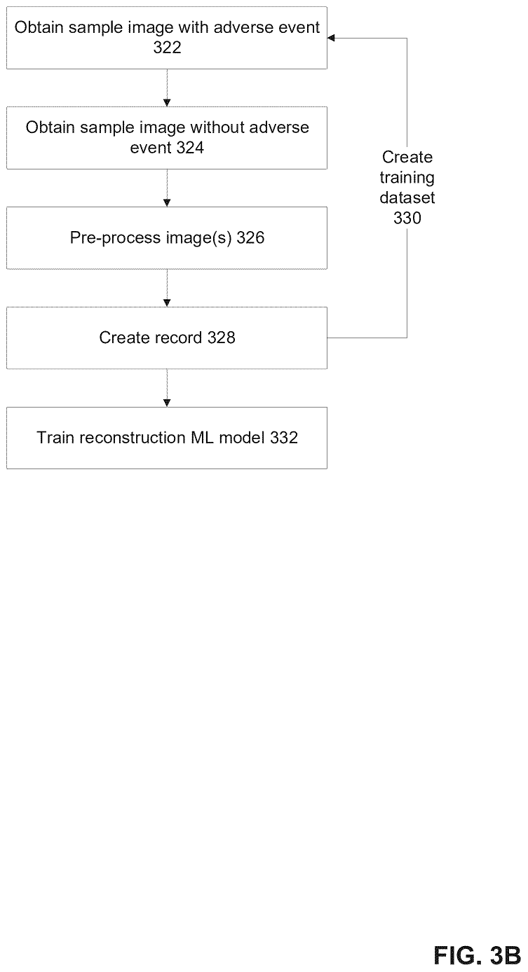

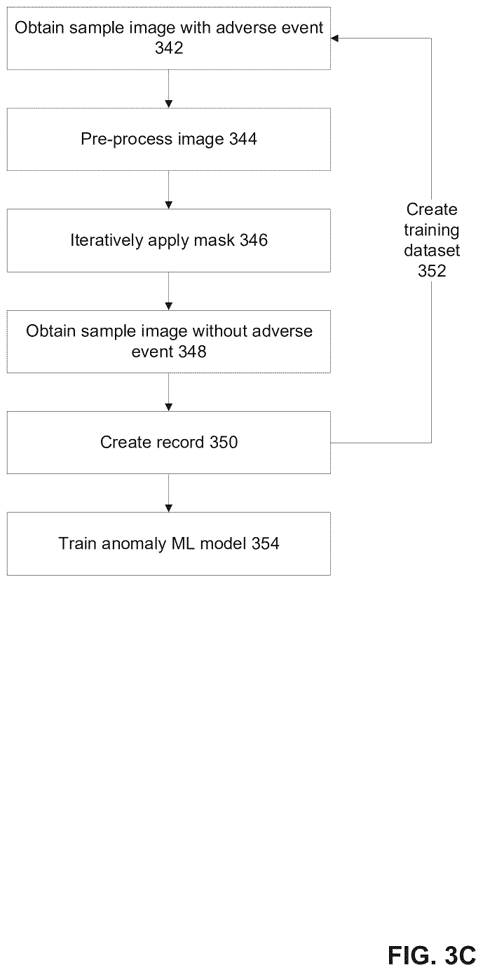

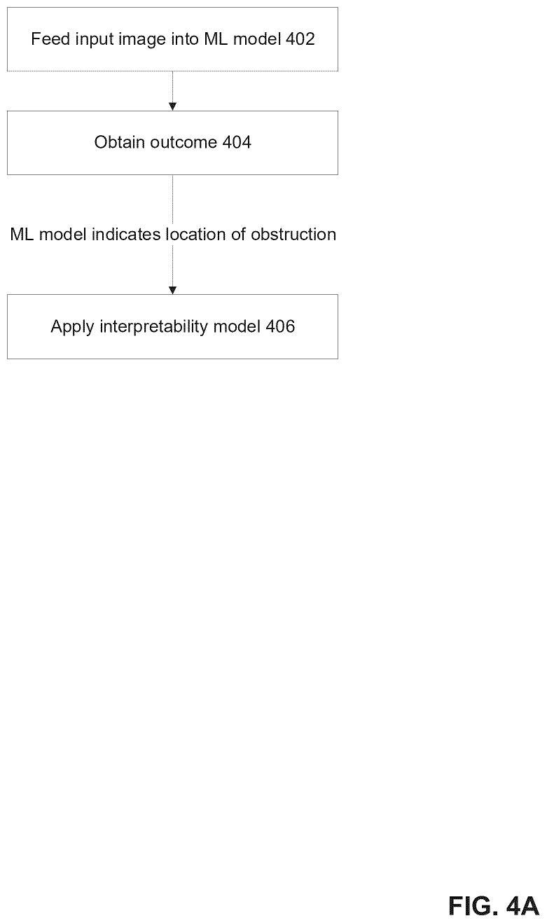

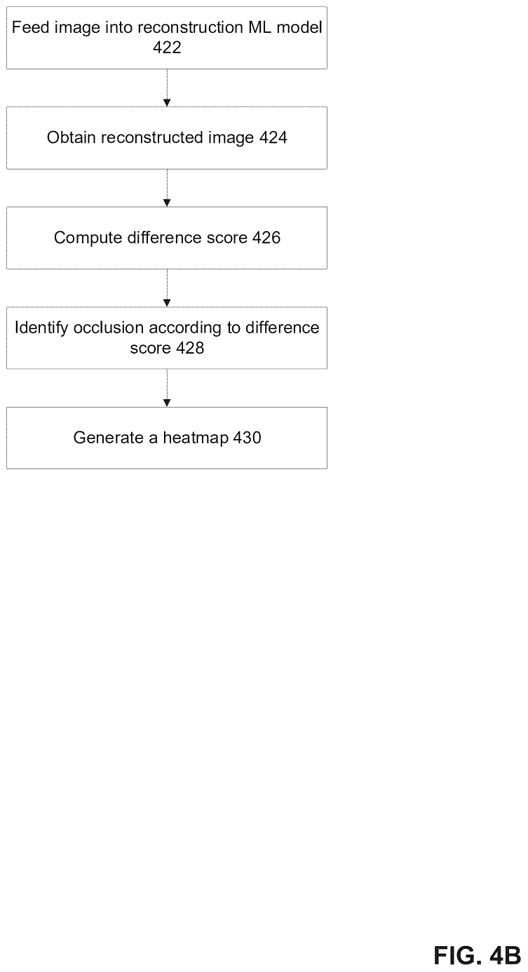

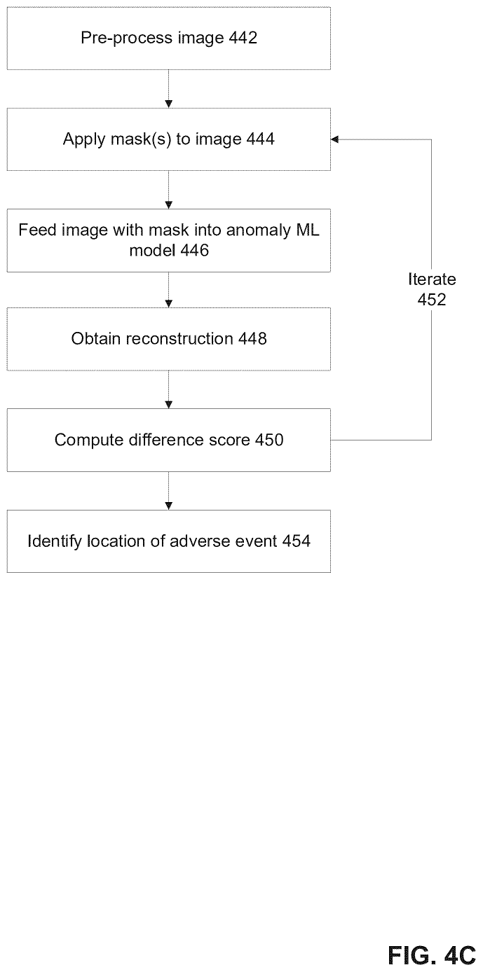

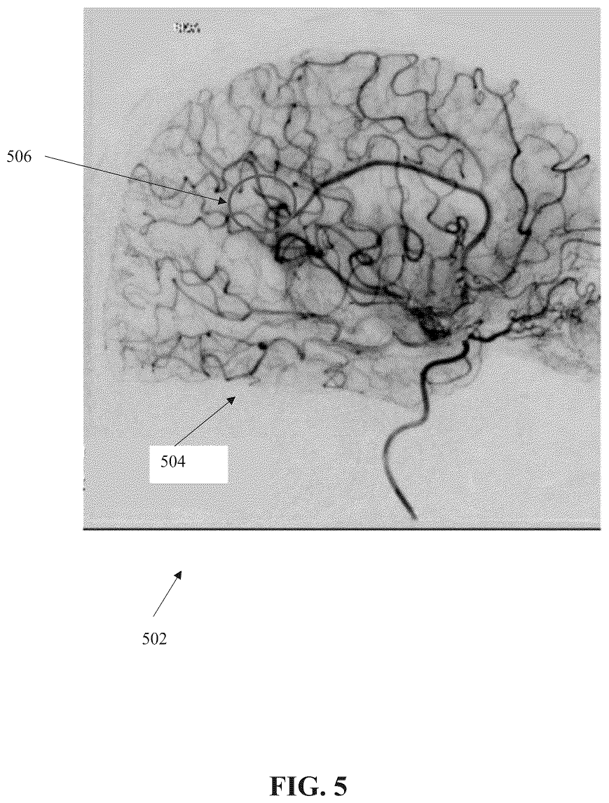

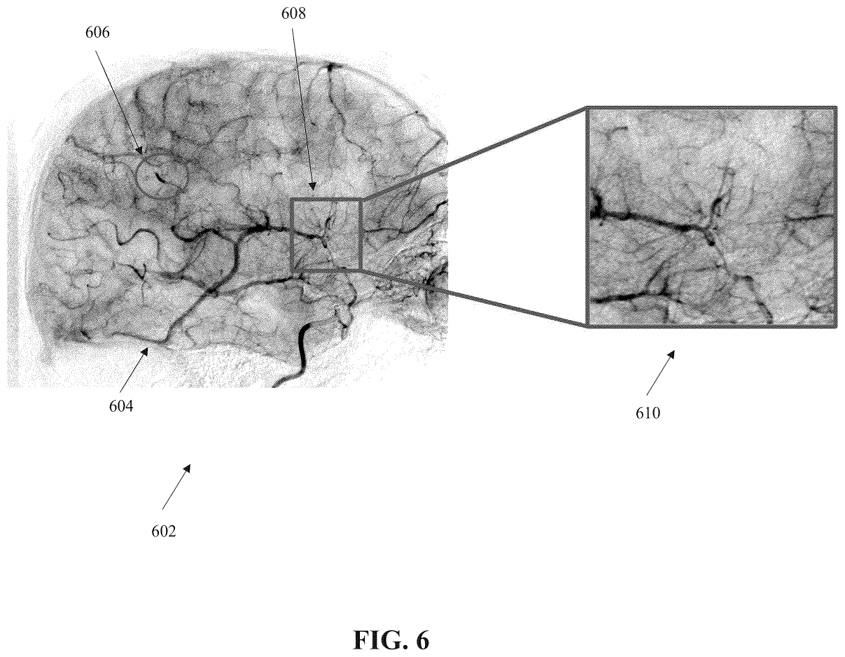

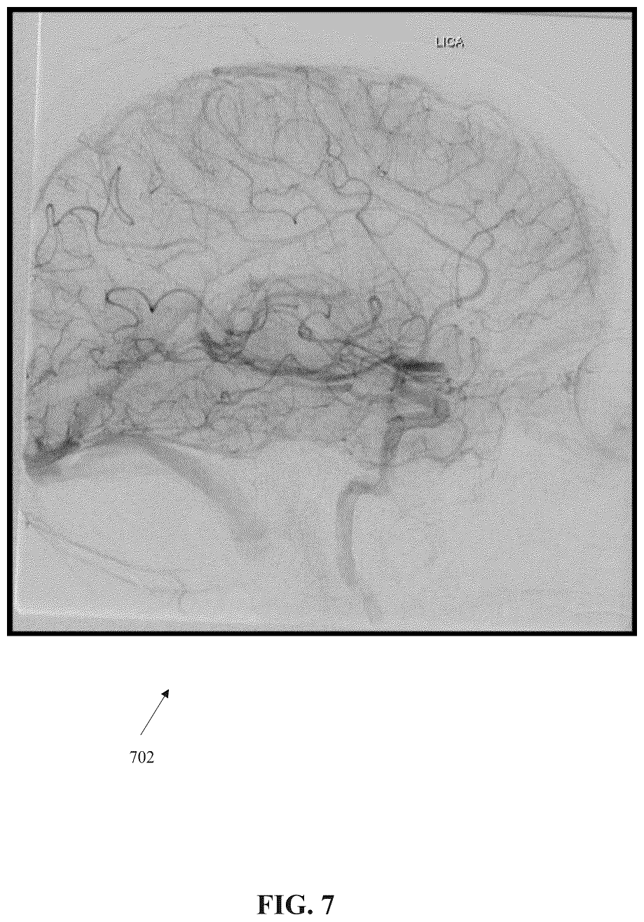

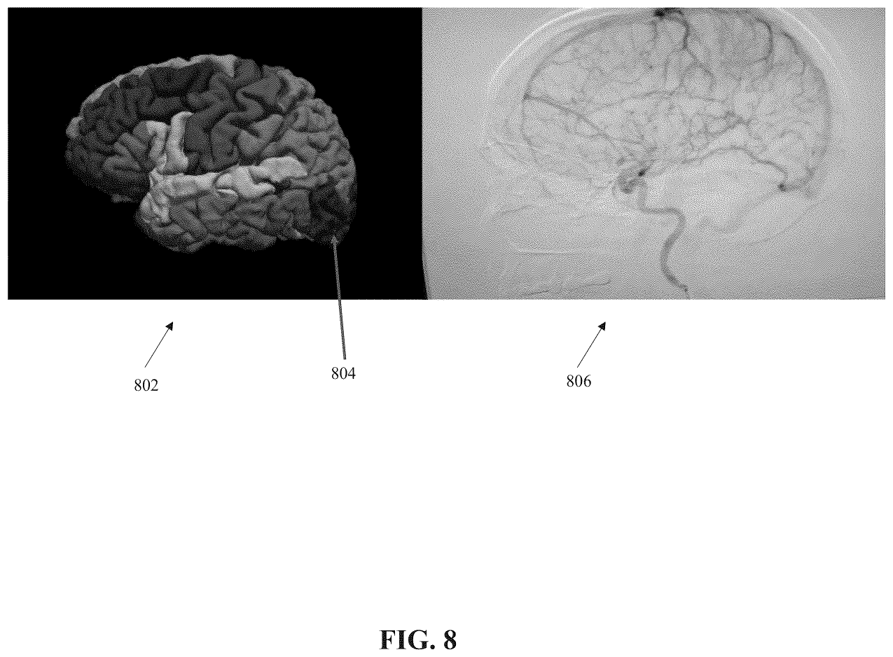

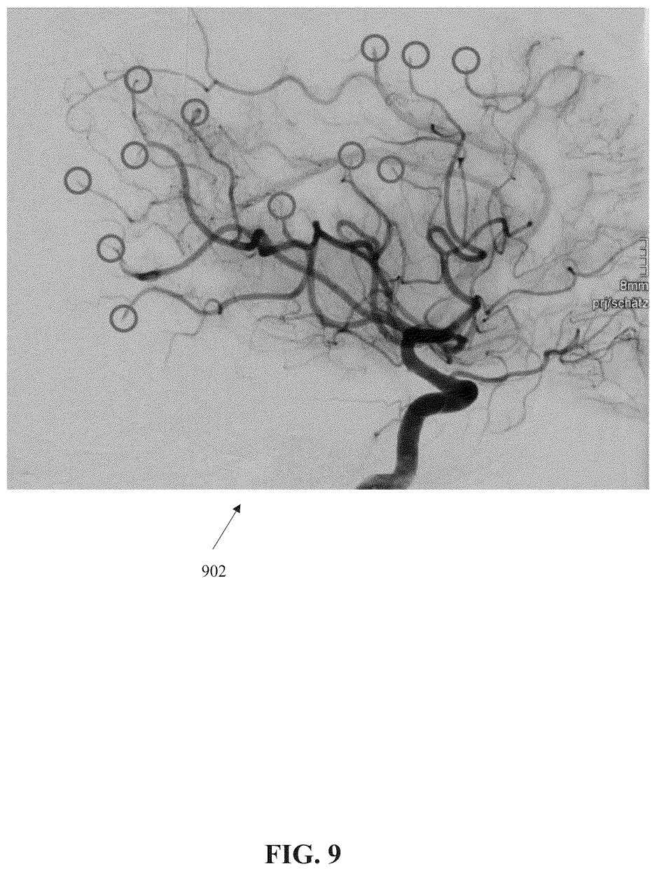

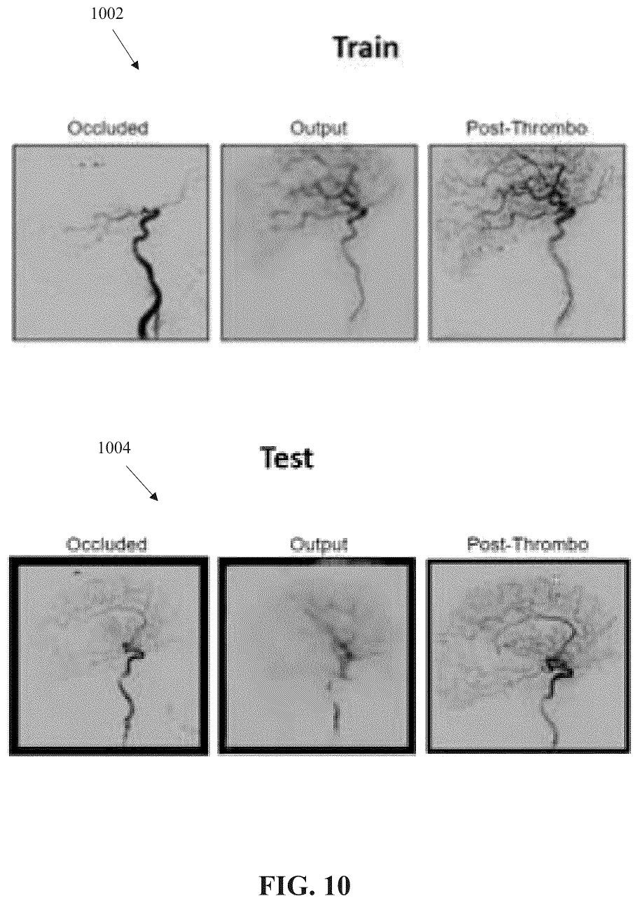

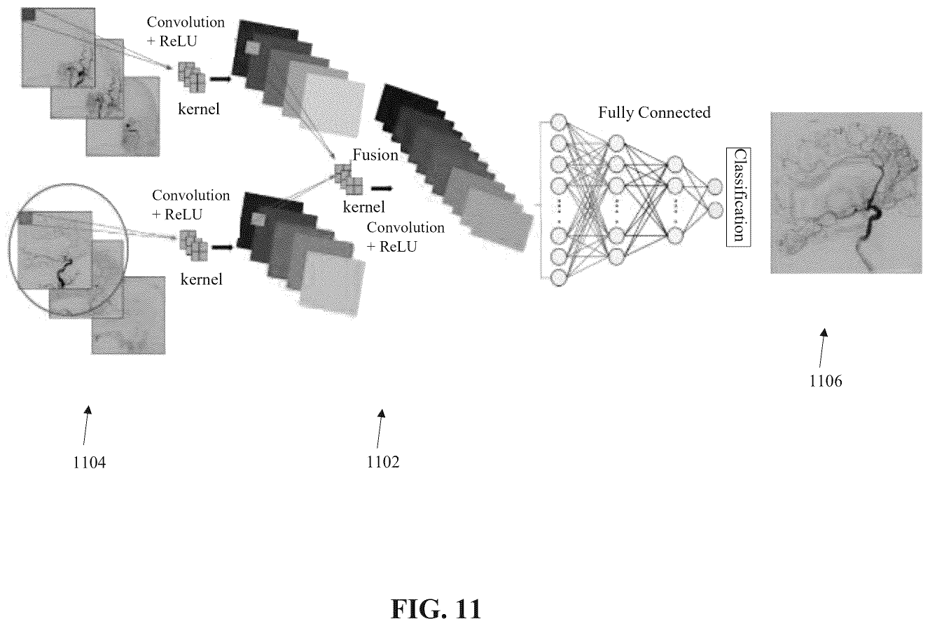

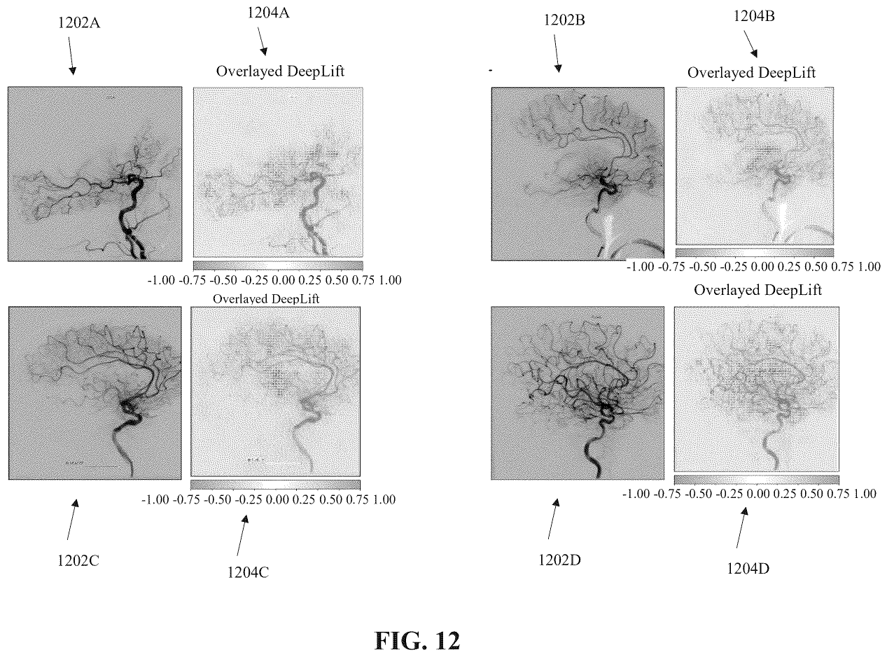

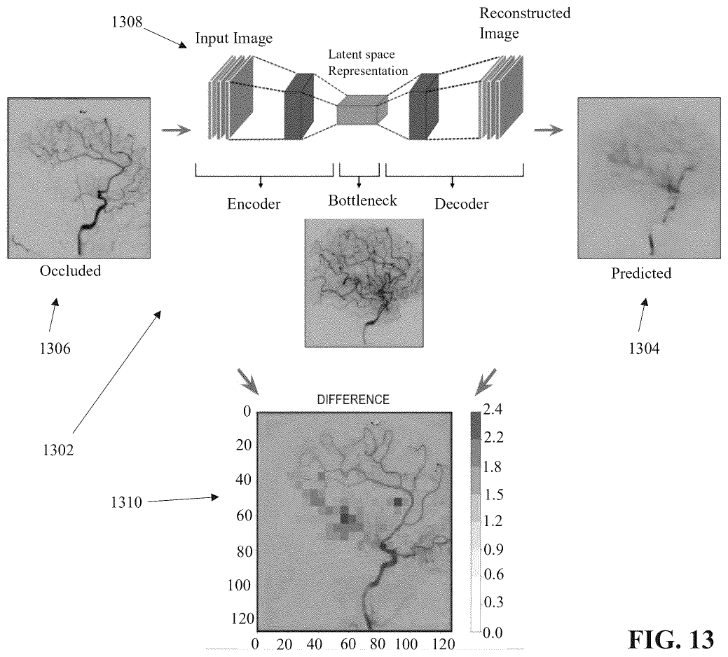

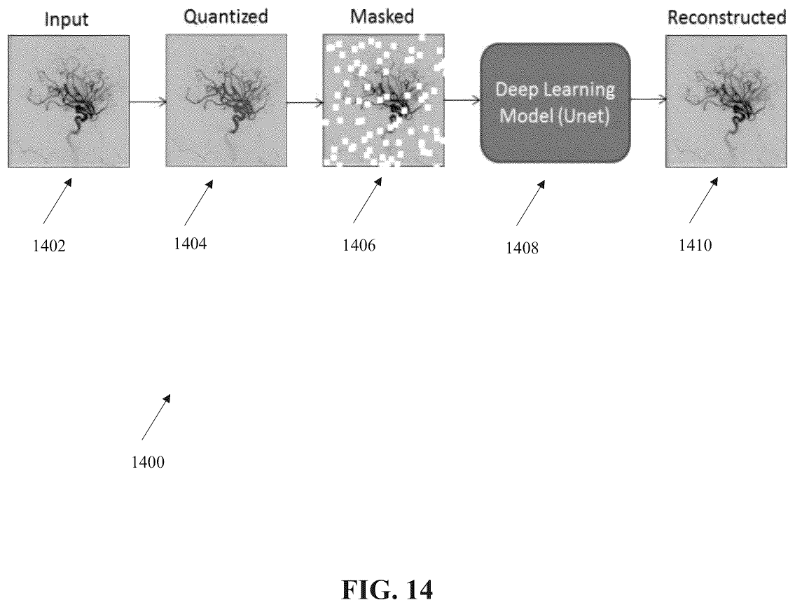

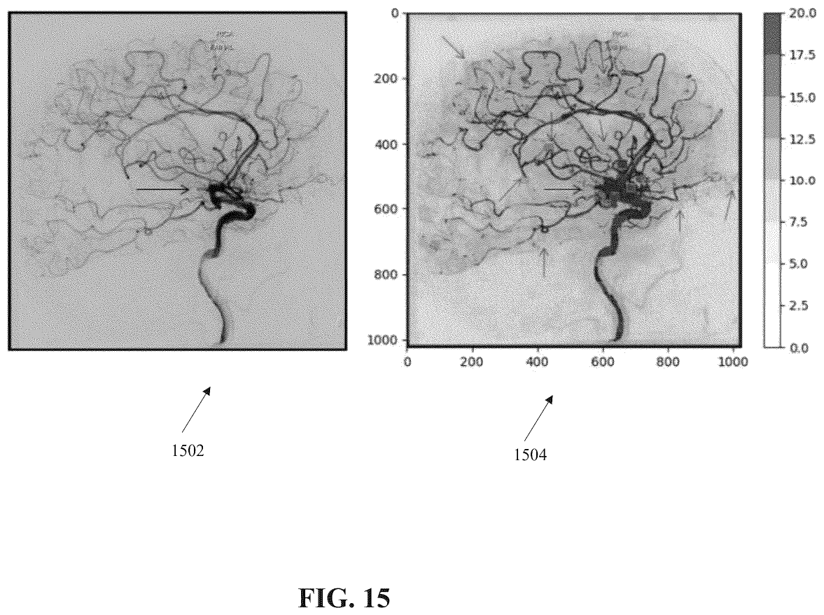

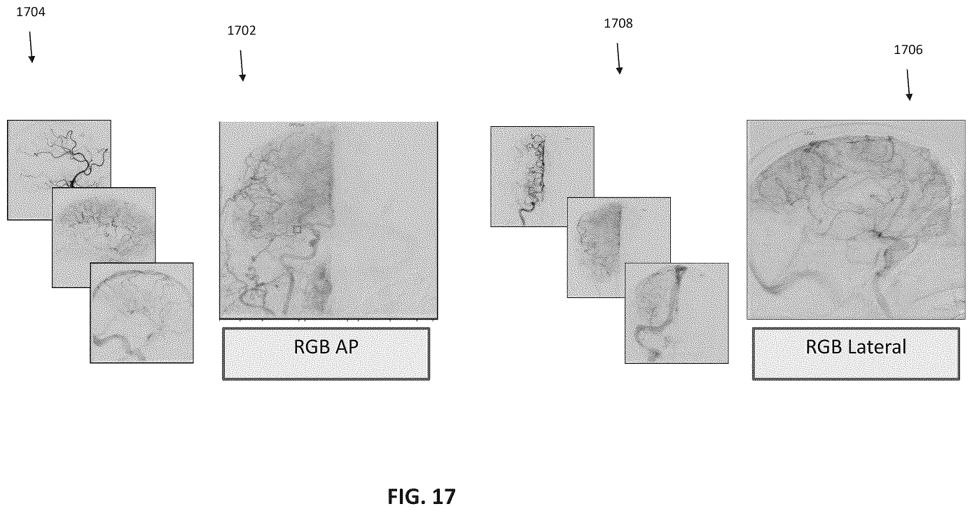

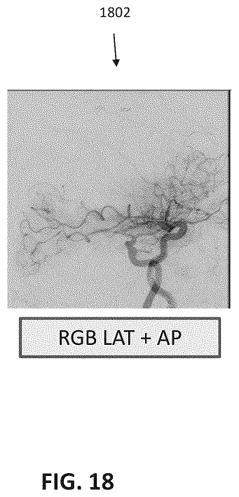

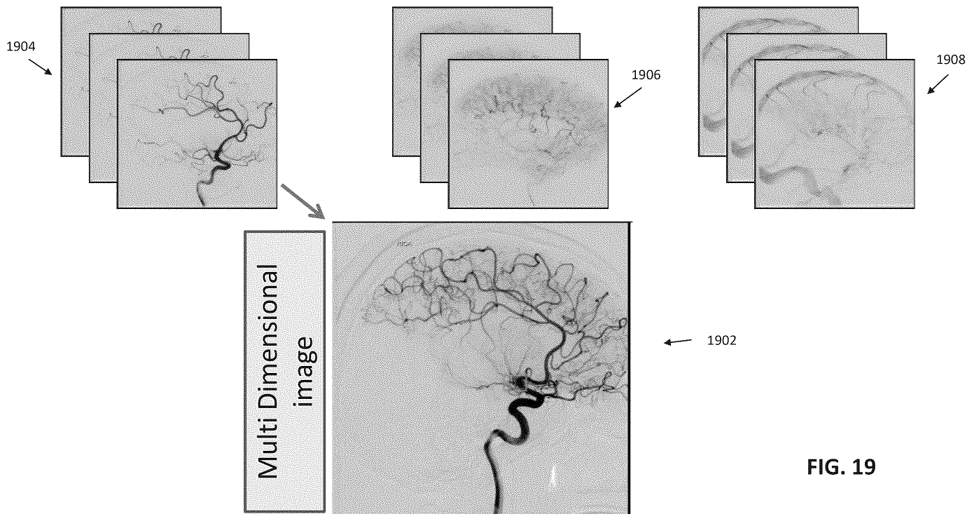

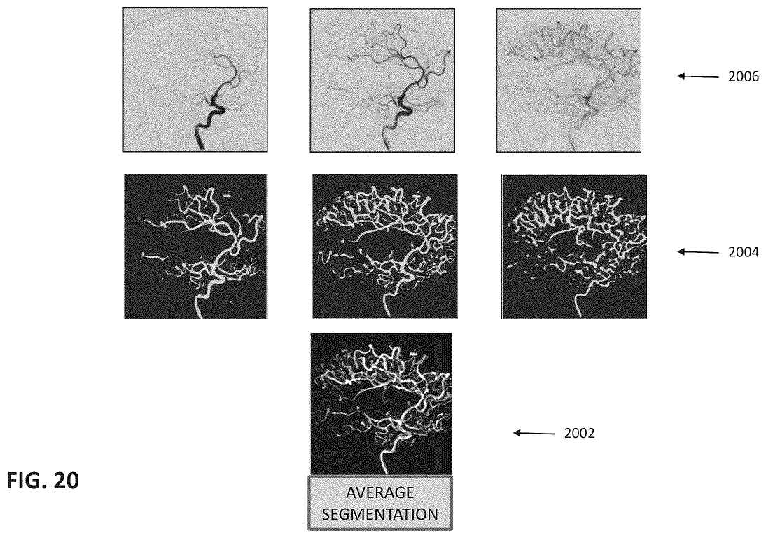

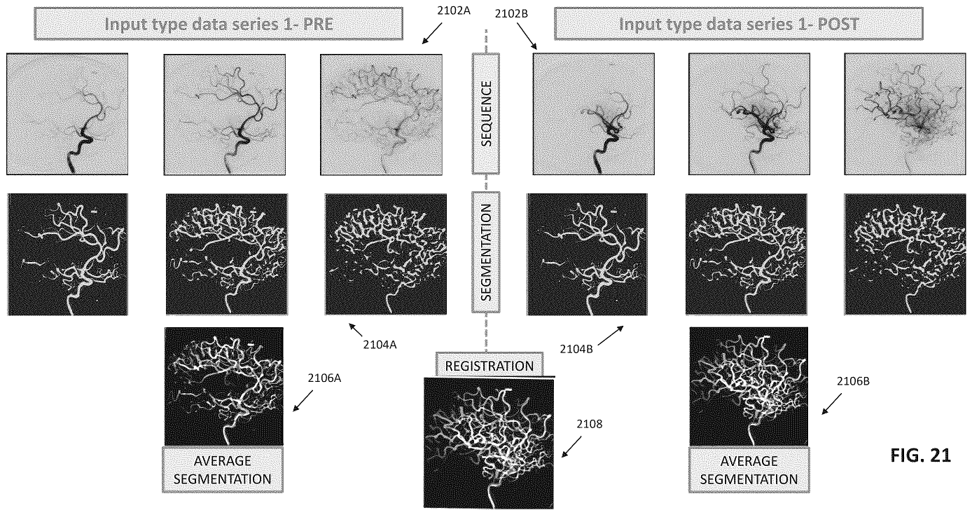

Reference is now made to FIG. 1, which is a block diagram of a system for identifying an adverse event of at least one blood vessel in an image, in accordance with some embodiments of the prevent invention. Reference is now made to FIG. 2, which is a flowchart of a method of identifying an adverse event of at least one blood vessel in an image, in accordance with some embodiments of the prevent invention. Reference is also made to FIG. 3A, which is a flowchart of a method of training a ML model for identifying an adverse event of at least one blood vessel in an image, in accordance with some embodiments of the prevent invention. Reference is also made to FIG. 3B, which is a flowchart of a method of training a reconstruction ML model for identifying an adverse event of at least one blood vessel in an image, in accordance with some embodiments of the prevent invention. Reference is also made to FIG. 3C, which is a flowchart of a method of training an anomaly ML model for identifying an adverse event of at least one blood vessel in an image, in accordance with some embodiments of the prevent invention. Reference is also made to FIG. 4A, which is a flowchart of a method of inference by the ML model for identification of the adverse event, in accordance with some embodiments of the prevent invention. Reference is also made to FIG. 4B, which is a flowchart of a method of inference by the reconstruction ML model, in accordance with some embodiments of the prevent invention. Reference is also made to FIG. 4C, which is a flowchart of a method of inference by the anomaly ML model, in accordance with some embodiments of the prevent invention. Reference is also made to FIG. 5 which is an image of a cerebral vascular tree in which an occluded vessel has been identified post procedure, to help understand some embodiments. Reference is also made to FIG. 6 which is another image of a cerebral vascular tree in which an occluded vessel has been identified in a zoom-in field of view, to help understand some embodiments. Reference is also made to FIG. 7 which is a 3 channel image, where each one of the three colors represents a different contrast phase, in accordance with some embodiments of the present invention. Reference is also made to FIG. 8 which is an image of a brain indicating an example of a correlation between an occlusion detected during a catheterization procedure and functionality of the region of the brain impacted by the occluded vessel, in accordance with some embodiments of the present invention. Reference is also made to FIG. 9 which is a schematic depicting an example of a map of brain vasculature generated per subject being treated, designed for navigation (e.g., optimal navigation) to the different vessels along the vasculature tree, in accordance with some embodiments of the present invention. Reference is also made to FIG. 10 which includes examples of training images and test images of the reconstruction ML model, in accordance with some embodiments of the present invention. Reference is also made to FIG. 11 which is a schematic depicting an exemplary ML model for classifying an input image as occluded or non-occluded (e.g., healthy) and a heatmap, in accordance with some embodiments of the present invention. Reference is also made to FIG. 12 which includes examples of input images fed into the ML model for classification of input images and a heatmap outcome generated based on the ML model, in accordance with some embodiments of the present invention. Reference is also made to FIG. 13 which is a schematic of an exemplary ML model for reconstructing a non-occluded image of an input occluded image, in accordance with some embodiments of the present invention. Reference is also made to FIG. 14 which is a schematic of an exemplary process for reconstruction of an unmasked image using the trained anomaly ML model, in accordance with some embodiments of the present invention. And reference is also made to FIG. 15 which depicts an example of an image with occluded vessel (left pane) and example output generated by the anomaly ML model, where square masked regions with high difference scores are marked, in accordance with some embodiments of the present invention. Reference is also made to FIG. 16, which includes examples of the first type of image selected in pre-processing, in accordance with some embodiments of the present invention. Reference is also made to FIG. 17, which includes examples of the second type of aggregated image computed in pre-processing, in accordance with some embodiments of the present invention. Reference is also made to FIG. 18, which includes an example of the third type of aggregated image computed in pre-processing, in accordance with some embodiments of the present invention. Reference is also made to FIG. 19, which includes an example of the fourth type of aggregated image computed in pre-processing, in accordance with some embodiments of the present invention. Reference is also made to FIG. 20, which includes an example of the fifth type of aggregated image computed in pre-processing, in accordance with some embodiments of the present invention. Reference is also made to FIG. 21, which depicting further processing based on the averaged segmented image of FIG. 20, in accordance with some embodiments of the present invention.

Referring now back to FIG. 1, system 100 may execute the acts of the method described with reference to FIG. 2-21, for example, by a hardware processor(s) 102 of a computing device 104 executing code 106A stored in a memory 106.

Computing device 104 receives medical images 116, which may be captured by medical imaging devices(s) 112, for example, 2D fluoroscopy images (e.g., angiography) images captured by an x-ray machine during an angiogram and/or catheterization procedure. The images 116 captured by medical imaging devices(s) 112 may be stored in an image repository 114, for example, data storage device 122 of computing device 104, a storage server 118 such as a picture archiving and communication system (PACS) server and/or electronic health record (EHR) server, a data storage device, a computing cloud, virtual storage, and a hard disk. Computing device 104 feeds medical image(s) 116 into one or more ML model(s) 112A, for detecting an adverse event, for example, blockage of a blood vessel, as described herein. Computing device 104 may use medical image(s) for creating training dataset(s) 122B for training ML model(s) 122A, as described herein.

Computing device 104 may be implemented as, for example, a catheterization laboratory workstation, a radiology workstation, a surgical workstation, a client terminal, a virtual machine, a server, a virtual server, a computing cloud, a group of connected devices, a desktop computer, a thin client, and a mobile device (e.g., a Smartphone, a Tablet computer, a laptop computer, a wearable computer, glasses computer, and a watch computer). Computing device 104 may include an advanced add-on to a catheterization laboratory workstation and/or a radiology workstation for presenting, for example, an identified location of a blockage in a blood vessel, identified brain functionality impacted by the blocked vessel, and a computed navigation route for navigating from a selected location (e.g., of a catheter) to the blockage.

Multiple architectures of system 100 based on computing device 104 may be implemented. For example:
Computing device 104 executing stored code instructions 106A, may be implemented as one or more servers (e.g., network server, web server, a computing cloud, a virtual server) that provides services (e.g., one or more of the acts described with reference to FIG. 1) to one or more client terminals 108 (e.g., remotely located remote catheterization laboratory workstations) over a network 110. For example, providing software as a service (Saas) to the client terminal(s) 108, providing software services accessible using a software interface (e.g., application programming interface (API), software development kit (SDK)), providing an application for local download to the client terminal(s) 108, providing an add-on to a web browser running on client terminal(s) 108, and/or providing functions using a remote access session to the client terminals 108, such as through a web browser executed by client terminal 108 accessing a web sited hosted by computing device 108. For example, client terminals access code 106A running on computing device 104 via web browsers running on the client terminals, client terminals download code 106A for local execution (e.g., for execution within an image viewing application running on a workstation), a plug-in that runs and/or accesses code 106A is installed on the web browser running on the client terminals, and/or client terminals use an API to access code 106A running on computing device 104. In such implementation, image(s) 116 captured by medical image device(s) 112 may be provided to computing device 104, over network 110. The image(s) 116 may be accessed by client terminal(s) 108 and/or provided by client terminal(s) 108 to computing device 104. Aggregated images computed from image(s) 116 are fed into ML model(s) 122A to obtain an indication of a location of an adverse event such as blockage of a blood vessel. The indication of the location and/or determined functionality of brain tissue impacted by the adverse event and/or a computed navigation route from a selected location to the adverse event, may be sent for presentation on a display of client terminal 108.
Computing device 104 may be implemented as a standalone device (e.g., catheterization laboratory workstation, client terminal) that includes locally stored code instructions 106A that implement one or more of the acts described with reference to FIGS. 2-21. The locally stored instructions may be obtained from another server (e.g., 118), for example, by downloading the code over the network, and/or loading the code from a portable storage device. In such implementation, each user uses their own computing device 104 to computed aggregated images from image 116 captured by medical imaging device(s) 112, and feeding the aggregated images into ML model(s) 122A. The outcome of ML model(s) 122A may be presented on a display in communication with the standalone device.
Computing device 104 may be integrated within treatment device 101, for example, as code installed on a workstation associated with treatment device 101, and/or in network communication with treatment device 101. For example, interventional radiologists and/or neurosurgeons using treatment device 101 to navigate a catheter to treat a blocked artery in a brain of a subject use code 106A to obtain the location of the blockage and/or navigation route for navigating the catheter to reach the blockage by the treatment device 101.

Creation of training dataset(s) 122B using image(s) 116 captured by medical imaging device(s) 112, and/or training of ML model(s) 122A using training dataset(s) 122B, may be performed by computing device 104, and/or by another remotely located computer.

Medical imaging devices 112 may be referred to as anatomical imaging devices and/or imaging modalities. Medical imaging devices 112 capture medical and/or anatomical images of subjects, depicting internal tissues of the body, for example, the brain. Medical imaging devices 112 may capture 2D images, 2D datasets Exemplary medical imaging device(s) 112 include: an x-ray machine capturing fluoroscopy images (i.e., fluoroscopy machine).

Computing device 104 may receive images 116 (e.g., captured by medical imaging device(s) 112) using one or more imaging interfaces 120, for example, a wire connection (e.g., physical port), a wireless connection (e.g., antenna), a local bus, a port for connection of a data storage device, a network interface card, other physical interface implementations, and/or virtual interfaces (e.g., software interface, virtual private network (VPN) connection, application programming interface (API), software development kit (SDK)). Processor(s) 102 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include one or more processors (homogenous or heterogeneous), which may be arranged for parallel processing, as clusters and/or as one or more multi core processing units.

Memory 106 (also referred to herein as a program store, and/or data storage device) stores code instruction for execution by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more acts and/or features of the method described with reference to FIGS. 2-21.

Computing device 104 may include a data storage device 122 for storing data, for example, the obtained images 116, ML model(s) 112A as described herein, and/or training dataset(s) 122B based on images 116 for training the ML model(s) 112A. Data storage device 122 may be implemented as, for example, a memory, a local hard-drive, a removable storage device, an optical disk, a storage device, and/or as a remote server and/or computing cloud (e.g., accessed over network 110). It is noted that code 122A-B may be stored in data storage device 122, with executing portions loaded into memory 106 for execution by processor(s) 102.

Computing device 104 may include data interface 124, optionally a network interface, for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

It is noted that imaging interface 120 and data interface 124 may exist as two independent interfaces (e.g., two network ports), as two virtual interfaces on a common physical interface (e.g., virtual networks on a common network port), and/or integrated into a single interface (e.g., network interface).

Computing device 104 may communicate using network 110 (or another communication channel, such as through a direct link (e.g., cable, wireless) and/or indirect link (e.g., via an intermediary computing device such as a server, and/or via a storage device) with one or more of:
Server(s) 118, for example, to obtain images 116, and/or obtain an updated version of code 106A and/or code 122A-B. Server(s) 118 may include the PACS server that stores images 116 captured by medical image device(s) 112.
Client terminal(s) 108, for example, when computing device 104 acts as a server providing services to the client terminals 108 as described herein.
Image repository 114 that stores images 116 captured by medical imaging device(s) 112.
Treatment device 101 that administers treatment to the location of an adverse event (e.g., blocked blood vessel) identified in image(s) 116 by ML model(s) 122A, for example, catheter navigation robot, device for manual navigation of catheter, device for automated and/or manual operation of the catheter for applying treatment.

Computing device 104 and/or client terminal(s) 108 includes or is in communication with a physical user interface 126 that includes a mechanism designed for a user to enter data and/or view data. Exemplary physical user interfaces 126 include, for example, one or more of, a touchscreen, a display, a keyboard, a mouse, and voice activated software using speakers and microphone.

Referring now back to FIG. 2, at 202, one or model ML models for identifying the adverse event in a blood vessel depicted in an image are accessed and/or trained.

Images (e.g., fluoroscopy) obtained during prior catheterization procedures performed on multiple subjects may be classified (e.g., manually and/or automatically by a processor executing code), for example, to two or more classification categories, including first images depicting occlusion (or other adverse event) and corresponding images in which the vessel(s) of the first image (e.g., that were previously occluded) no longer have the occlusion. The first images include images depicting occlusions. Corresponding images are images of non-occluded (e.g., “healthy”) brains, optionally after the occlusion (e.g., clot), shown in the first images, was opened during the procedure. These images may be further categorized (e.g., manually and/or automatically by a processor executing code) into three additional blood flow phases-arterial, parenchymal and venous, and/or into two planes-anterior-posterior (AP) and lateral. The pairs of images (occlusion and non-occluded) classified into the different classification categories may be arranged into different training datasets for training one or more machine learning models.

Exemplary approaches for training of three exemplary ML models are described with reference to FIGS. 3A-3C.

The ML model(s) may be trained using an unsupervised approach, without labels denoting locations of the adverse event (e.g., occluded blood vessels) in the training images depicting the adverse event (e.g., occluded vessels). Alternatively or additionally, the ML model(s) are trained using a supervised approach, by applying labels denoting locations of the occluded blood vessels in the training images depicting the occluded vessels. In other embodiments, supervised ML model may be used for labeled data.

At 204, one or more images are accessed.

The image(s) are of time-spaced sequential images.

The image may be referred to herein as an anatomical image. The phrases anatomical image and image(s) of time-spaced sequential images may be used interchangeably.

The image(s) may be fluoroscopy image(s), such as 2D fluoroscopy image(s).

Each image may be computed by DSA, for example, using standard approaches.

Optionally, individual images are accessed and analyzed, for example, at a sampling rate of an image a second, an image every 5 seconds, and the like. Alternatively, a sequence of time spaced images over a time interval are accessed an analyzed. For example, multiple frames obtained over the time interval (e.g., second, 3 seconds, 5 seconds), or multiple sampled frames obtained over the time interval (e.g., every 1 second over 10 seconds, every 0.5 seconds over 3 seconds). Alternatively, multiple images are obtained from different events, for example, during different contrast phases, for example, prior to contrast, arterial phase, venous phase, parenchyma phase washout, and the like. Alternatively, multiple images are captured at one or more different anatomical planes, for example, by rotating the C-arm (which captures x-ray images) to different angles.

The images may be captured in real-time or near real-time during a procedure involving blood vessels, for example, angiography and/or catheterization.

The images may be two dimensional (2D) images, for example, x-ray (e.g., 2D fluoroscopy) images.

The images may depict blood vessels of internal anatomical features of the body, optionally blood vessels of the brain.

Optionally, the images depict contrast introduced into vasculature. Optionally, the images depict contrast introduced into the arterial tree, optionally the atrial tree of the brain.

The image are analyzed by the ML model(s) as described herein for identifying of an adverse event that developed during the angiography and/or catheterization procedure.

Referring now back to FIG. 5, an example of an input image 502 of a cerebral vascular tree 504 is shown. Input image 502 is fed into one or more ML models described herein, for identifying an occlusion 506, optionally in real-time during the procedure, rather than after the procedure, enabling faster response.

Referring now back to FIG. 6, another example of an input image 602 of a cerebral vascular tree 604 is shown. Input image 602 is fed into one or more ML models described herein, for identifying occluded vessels 606 and 608. A zoom-in field of view 610 of occlusion 608 is depicted. Embodiments described herein may identify such occlusions in real-time during the procedure, rather than after the procedure, enabling faster response.

Referring now back to FIG. 2, at 206, the image(s) may be pre-processed.

Optionally, an aggregated image (which is used as an input image fed into the ML model(s) is computed from multiple images, optionally from multiple individual DSA images.

In the case of multiple images obtained during multiple contrast phases (e.g., arterial phase, parenchyma phase, and venous phase), the aggregated image may be computed by applying a different label to each respective image obtained during a respective contrast phase, i.e., multiple labels corresponding to the multiple contrast phases. Optionally, each different label is a different color, and the aggregated image is a multi-colored image where each color denotes a different contrast phase.

Optionally, multiple time-spaced sequential images captured over a time interval, are accessed. The time-spaced sequential images depict blood vessels of the tissue in at least one contrast state (e.g., arterial phase, parenchyma phase, and venous phase) and/or in at least one image plane. For example, a sequence of frames of a video (e.g., CINE) captured during the time interval.

The aggregated image may be created by concatenating and/or stacking the time-spaced sequential images, to form a single image, which may be a multi-channel images (e.g., similar to RGB) and/or a multi-dimensional image. Concatenating may refer to the multi-channel image. Stacking may refer to the multi-dimensional image.

The pre-processing may be performed on sample images used for training of the ML models. The sample images of records described herein may refer to a respective aggregated image created by concatenating and/or stacking time-spaced sequential images respectfully captured prior to treatment and after the adverse event has been treated (e.g., at least one occlusion has been opened).

Exemplary types of aggregated images which may be used as input images fed into the ML model(s) and/or used for training the ML models (also referred to herein as “input type data”, are now described.

A first exemplary type (input type data 1) of image, is not necessarily aggregated since it is obtained by selecting a single representative image from a single contrast phase and/or a single image plane.

A second exemplary type (input type data 2) of the aggregated image may be computed by concatenating and/or stacking one or more (e.g., a single) representative image sampled from each of the contrast states. A multi-channel image (e.g., RGB) may be created. The multi-channel image may be created per image plane.

A third exemplary type (input type data 3) of the aggregated image may be computed by concatenating and/or stacking at least one (e.g., a single) representative image sampled from each of multiple different image planes, optionally at a same contrast phase. A multi-channel image (e.g., RGB) may be created.

A fourth exemplary type (input type data 4) of the aggregated image may be computed by concatenating and/or stacking at least two consecutive images (up to a full series) selected from the time-spaced sequential images, optionally for a sample contrast phase. A multi-dimensional image may be created. The consecutive images may be spaced apart in time and/or separated by other frames not selected.

A fifth exemplary type (input type data 5) of the aggregated image may be computed by selecting two or more consecutive images from the time-spaced sequential images, segmenting (the blood vessels from) each of the consecutive images, and averaging the segmented images, to obtain a single averaged segmented image. The consecutive images that are segmented may be of a same contrast phase. The consecutive images may be spaced apart in time and/or separated by other frames not selected.

The different types of aggregated images may be used by different ML models described herein. For example:

ML model for identification of the adverse event: In order to compare between two series, for example that of the beginning of the procedure (pre) and the end of the procedure (post) or any other comparable sequences, any of the input type data types may be used, preferably input type data 5. The input type data of series 1 may be registered to input type data of series 2, resulting in an aligned image from input type data series 1 to input type data series 2. Optionally a smoothing process is applied to both input type data series 2 and the aligned image. A comparison between the resulting images may be done, for example, by creating a new “weighted-subtracted” image by which (e.g., only) the pixels from one of the two resulting images either input type data series 2 or the aligned image that are significantly higher in value are displayed.

Reconstruction ML model: Any of the input type data may be used, preferably input type data 4 or 5. The input image is fed into a pre-trained ML model (e.g., RES-NET), resulting in a classification of the input data to a “healthy” vs. pathological brain with an occlusion. Anomaly ML model: Any of the input type data may be used, preferably input type data 4 or 5. The input image is fed into a pre-trained ML model (e.g., RES-NET), resulting in a prediction of an occlusion location (based on the annotated/tagged images).

Possible options for pre-trained ML models are to use data from neuro-endovascular procedures. One option can be to train the ML model to learn a labeled occluded parenchyma. A second option can be to train the ML model to learn features of a diagnostic “healthy” or with other pathologies brain image.

Referring now back to FIG. 16, example images 1602 of the first type of image, as shown. Images 1602 include single sample images obtained for an AP plane and a lateral plane, for the arterial, parenchymal, and venous contrast phases.

Referring now back to FIG. 17, a multi-channel (RGB) image 1702 is created by concatenating and/or stacking images 1704 captured at the arterial, parenchymal, and venous contrast phases, for the AP image plane. A multi-channel (RGB) image 1706 is by concatenating and/or stacking images 1708 captured at the arterial, parenchymal, and venous contrast phases, for the lateral image plane. It is noted that multi-channel image 1706 of FIG. 17 is the same as aggregated image 702 described with reference to FIG. 7.

Referring now back to FIG. 18, a multi-channel (RGB) image 1802 is created by concatenating and/or stacking images captured at different image planes.

Referring now back to FIG. 19, a multi-dimensional image 1902 is created by concatenating and/or stacking two or more sequential images, for example, for respective contrast phases (e.g., image sets 1904, 1906, and 1908).

Referring now back to FIG. 20, a single averaged segmented image 2002 is created by averaging segmented images 2004, which are created by segmenting blood vessels from consecutive images 2006.

Referring now back to FIG. 21, images 2102A are first image depicting the adverse event in blood vessel(s) (e.g., occlusion), while images 2102B are corresponding images that do not depict the adverse event (e.g., non-occluded) that is depicted in the first image (e.g., occlusion has been opened). Images 2104A are segmentations of the blood vessels of images 2102A, and images 2104 are segmentations of the blood vessels of images 2104B. Image 2106A is an average of segmentations 2104A, and image 2106B is an average of segmentations 2104B. Registration image 2108 is obtained by registering images 2106A and 2106B.

Referring now back to FIG. 7, which is an example of an aggregated image 702 of three colors, also referred to herein as a three color image or three channel image. Each one of the three colors represents a different contrast phase. The three color image may be used for training and/or inference, as described herein. The three color image is created, as described herein. It is noted that that aggregated image 702 of FIG. 7 is the same as multi-channel image 1706 described with reference to FIG. 17.

Referring now back to FIG. 2, at 208, the image depicting the blood vessels is fed into one or more of the ML model(s). The image fed into the ML model(s) may refer to the aggregated image and/or to a sequence of multiple images.

The ML model may combine features extracted from the multiple images to obtain the outcome.

At 210, in response to no adverse event being identified by the ML model, features described with reference to 204-208 may be iterated, optionally in real-time or near real-time during the ongoing procedure (e.g., angiography and/or catheterization).

Input images captured in real-time or near real-time during the procedure (e.g., angiography and/or catheterization) procedure are iteratively fed into the ML model for near real-time detection of an obstruction of a vessel occurring during the catheterization procedure.

Each iteration may be performed over a respective time interval during which a set of time-spaced sequential images are captured, to generate a respective aggregated image. For example, frames captured at a certain frame rate over, for example, about 1 second or 3 seconds, or 5 seconds, or 1 minute, or 5 minutes, or 10 minutes, or other values, which may depend on the amount of time for contrast to appear and/or disperse over one or more contrast states.

At 212, alternatively to 210, an adverse event in a vessel depicted in a certain image (also referred to herein as an anatomical image) is obtained as an outcome of the ML model.

Optionally, a location of the adverse event within the image is computed. For example, the location within the blood vessel in which the adverse event occurred is identified.

The location of the adverse event within the image may be indicated, for example, by an overlay is generated over the location of the vessel in which the adverse event occurred depicted one or more of the time-spaced sequential images and/or over the aggregated image. The overlay may include a color coding of the location, an arrow pointing to the location, a bounding box, a heatmap, and the like.

In another example, coordinates (e.g., of pixels) indicating the location of the vessel in which the adverse event occurred may be computed and provided.

Exemplary approaches for obtaining the adverse event as an outcome of the ML model(s), and/or for computing the location of the adverse event within the image, are described with reference to FIGS. 4A-4C.

At 214, in the case of an adverse event occurring in a blood vessel of the brain, functionality of brain tissue impacted by the adverse event may be computed.

Optionally, an anatomical image (e.g., x-ray) of the images in which the adverse event was identified (e.g., that were used to compute the aggregated image) is registered with a reference image indicating function of the brain tissue to deduce functionality of the region likely impacted by the occluded vessel. The reference image may be, for example, a functional MRI image, a CT angiography image (e.g., captured prior to the current catheterization procedure, a brain atlas. Alternatively or additionally, the aggregated image is registered with the reference image. Alternatively or additionally, a combined image is created from the anatomical image and the reference image. Brain functionality likely impacted by the adverse event of the identified vessel may be determined by mapping the location of the adverse event (e.g., occluded vessel) of the x-ray image to a location on the reference image. For example, the reference image (which may be mapped to a functional atlas of the brain) indicates different regions of the brain, and the function of each region. The anatomical image indicates the blood vessels of the brain. The registration and/or combined image indicates the blood supply to the different functional regions of the brain, enabling identifying the function impacted by the affected blood vessel in response to reduced or stopped blood supply to the region of the brain.

In yet another example, functionality of different organs (e.g., liver lobe, parts of the intestine, heart) that are impacted by an adverse event of blood vessels (e.g., bleeding, injury) may be determined.

Referring now back to FIG. 8, a reference image 802 of a brain indicating different functional regions (e.g., one region 804 is indicated) is presented along with an x-ray angiographic image 806 of the brain obtained during a catheterization procedure. Reference image 802 may be a previously acquired image, for example, a CTA and/or MRI and/or fMRI scan. Reference image 802 may be correlated and/or registered with x-ray 806, to determine functionality of the region of the brain impacted by the occluded vessel. The impacted blood vessel may be mapped to its functional regions, for example for assisting the endovascular neurosurgeon to recognize whether important brain structures are at risk and/or additional intervention is critical.

Referring now back to FIG. 2, at 216, a navigation route may be computed from a selected location in the vasculature to a location of the identified adverse event in the blood vessel. For example, the navigation route is computed from an identified current location of a catheter for treatment of the obstructed vessel and/or complication of bleeding and/or dissection, to the location of the blood vessel that is experiencing the adverse event (i.e., pathological vessel), for example, for treatment of the pathological vessel. Alternatively, a user may manually mark a selected blood vessel on the image, for example, using a user interface in which the user clicks and/or touches (on a touch screen) a certain vessel. The navigation route is computed from the selected location to the adverse event.

The navigation route may be computed, for example, by adapting a navigation application, such as a road route navigation application used by drivers of cars.

The navigation route may be presented, for example, as an overlay over an anatomical image presented on a display. The anatomical image may be selected from the time-spaced sequential images (e.g., 2D fluoroscopy images) used to compute the aggregated image. For example, as a coloring, bolding, and/or pattern, overlaid on the blood vessels to traverse by the navigation route.

In another example, the navigation route may be computed by computing a tree data structure and/or graph data structure (e.g., directed and/or acyclic) for the blood vessels depicted in the image. A route between two points in the tree data and/or graph data structure may be computed.

Referring now back to FIG. 9, an example of a map 902 of brain vasculature generated per subject being treated, designed for navigation (e.g., optimal navigation) to the different vessels along the vasculature tree, is presented.

At 218, the subject may be diagnosed and/or treated according to the location of the adverse event and/or impacted functionality and/or navigation route.

In an example, the subject may be treated for the identified occluded vessel by opening the identified occluded vessel, for example, by mechanical removal of an embolism using a specially designed catheter, and/or by injecting a drug to dissolve the embolism using the specially designed catheter.

In another example, the subject may be treated for bleeding from the vessel and/or stopping the bleeding from the vessel, for example, by the specially designed catheter.

The specially designed catheter may be navigated to the location of the adverse event following the navigation route.

Referring now back to FIG. 3A, at 302, a first sample image depicting tissue (e.g., brain) of a subject including one or more occluded blood vessels (or other adverse event), optionally prior to treatment for opening the at least one occlusion, is accessed.

At 304, a corresponding sample image depicting the tissue of the subject without the occlusion(s) depicted in the first image, for example, after the occluded blood vessel(s) has been opened, is accessed.

At 306, the first sample images and/or the corresponding sample images may be pre-processed, for example, for computing aggregated images as described with reference to 206 of FIG. 2.

At 308, a record that includes a pair of training sample images (e.g., aggregated images) is created. The pair of images of the record include the sample image and the corresponding image. The pair of images may be used, for example, for unsupervised training, in which the ML model learns the difference between the images on its own. Alternatively, the record may include an individual image, which may be the first image or the corresponding image, labelled with a ground truth label. For example, obstructed or non-obstructed, adverse event or no adverse event, bleeding and no bleeding, dissection and no dissection, and the like. The labels may be used when a supervised training approach is used. Alternatively, the images are not labelled, such as when a non-supervised training approach is used.

The first image and the corresponding image may be captured with similar (i.e., substantially the same) parameters, for example, at the same (or similar) viewing angle, at the same (or similar) contrast stage, and at the same (or similar) exposure. The similar parameters may help the ML model learn to differentiate between the two images to identify the obstruction. Optionally, the image are labelled with an indication of the location of the obstructed vessel, for example, a bounding box is placed around the location of obstruction, and/or a marker is placed at the location of obstruction.

At 310, a training dataset that includes multiple records of sample images (e.g., aggregated images) for multiple subjects may be created. The training dataset may be created by iterating features described with reference to 302-308, where each iteration creates a record.

One or more pairs of images (e.g., aggregated images) may include the first image (e.g., aggregated image) and the corresponding image (e.g., aggregated image) that both exclude a depicted obstructed vessel. Both the first image and corresponding image may be of a non-obstructed vascular (e.g., arterial) tree, optionally of the brain.

At 312, the ML model for identification of an adverse event, optionally by classification of an input image, is trained on the training dataset.

The ML model may be trained using transfer learning and/or domain shift approaches, on at least one other pre-trained ML model which was trained on other sample fluoroscopy images such as other diagnostic images and/or images depicting adverse events

The ML model for identification of the adverse event may be implemented, for example, as a neural network, optionally conv net. The ML model is trained model to classify input images into the 2 classes (e.g., occluded or non-occluded). Heat maps may be computed by finding the pixels which contributed the most to the decision of the trained model, using an ML model interpretability model, for example, Deep Lift.

Referring now back to FIG. 3B, at 322, a first sample image depicting at least one blocked vessel may be accessed, for example, as described with reference to 302 of FIG. 3A.

At 324, a corresponding sample image depicting the vessel of the first without the blockage may be accessed, for example, as described with reference to 304 of FIG. 3A.

At 326, the first sample images and/or the corresponding sample images may be pre-processed, for example, for computing aggregated images, as described with reference to 306 of FIG. 3A.

At 328, a record including the first sample image and/or the corresponding sample image (e.g., aggregated images) may be created, for example, as described with reference to 308 of FIG. 3A.

The corresponding sample image represents a ground truth for comparing with a reconstruction of the first sample image that excludes the blockage of vessel(s) depicted in the first sample image.

At 330, a training dataset of multiple records of multiple sample images (e.g., aggregated images) of multiple sample subjects may be created by iterating features described with reference to 322-328. Each iteration creates a record of a different pair of first sample image and corresponding sample image used as ground truth.

Referring now back to FIG. 10, examples of training images 1002 and test images 1004 of the reconstruction ML model are shown.

Referring now back to FIG. 3B, at 332, the reconstruction ML model may be trained on the training dataset for generating a reconstructed image depicting an opened occlusion in a vessel in response to an input of the first image depicting the vessel with occlusion.

The reconstruction ML model may be trained using transfer learning and/or domain shift approaches, on at least one other pre-trained ML model which was trained on other sample fluoroscopy images such as other diagnostic images and/or images depicting adverse events.

The reconstruction ML model may be trained by inputting the first image (i.e., without occlusion and/or other adverse event) and generating a corresponding reconstructed image that excludes the occlusion, i.e., depicting the full level of the vessel which is occluded in the first image. A difference score between the reconstructed image outcome of the reconstruction ML model and the ground truth of the corresponding image may be computed. The difference score may be back propagated within the reconstruction ML model. The reconstruction ML model is trained for generating the reconstructed image while minimizing the difference score.

The difference score may be, for example, a L2 difference score.

The difference may be computed by convolving the input first image and the reconstructed image with a filter. The filter may include a mean filter that computes the mean of each square of a fixed size for the reconstructed image and for the input image.

The difference score may be computed for each square. The mean may be iteratively computed for each square of multiple squares that cover the input image and the reconstructed image.

The occlusion may be identified as one or more squares with the difference score greater than a threshold and/or a number of squares with highest difference scores.

The reconstruction ML model may generate a bounding box corresponding to the identified squares likely encompassing an occluded vessel, thereby indicating the location of the occluded vessel on the input image.

The reconstruction ML model may be implemented as, for example, a convolutional neural network and/or autoencoder.

The reconstruction ML model may use a reverse approach by which given an occluded image, the prediction ML model learns to reconstruct the image of the matching corresponding non-occluded (e.g., “healthy”) image. The reconstruction ML model may be trained to reconstruct a corresponding non-occluded (e.g., healthy) image (e.g., of the brain) from an occluded image (e.g., of the brain). In an exemplary architecture, an occluded image is fed into the prediction ML model, and then propagating back. The L2 difference (or other metric) may be computed between the output of the prediction ML model and the corresponding non-occluded (e.g., “healthy”) brain image. During the inference phase, a brain image (“simulating a “real-time” image) is fed into the trained prediction ML model. Both the new input and the output from the trained prediction ML model may be convolved with “mean filter” i.e., computing the mean of each square (of some fixed size) for both images, or other approaches may be used. Iterations may be performed over the squares computing the difference between the input and the output for each square (e.g., L2 difference). The areas which produce the biggest difference serve as the regions of interest.

Referring now back to FIG. 3C, at 342, a first image depicting at least one blocked vessel may be accessed, for example, as described with reference to 302 of FIG. 3A.

At 344, the first image may be quantified into multiple colors, for example, three (3), seven (7), or other number of colors. An aggregated image may be computed, for example, as described with reference to 206 of FIG. 2.

At 346, a mask(s) may be iteratively applied to different regions of the quantized first image (e.g., aggregated image), for covering the tissue of the first image. For example, covering all parts of the brain and/or blood vessels depicted in the first image. The mask may be shaped, for example, as a square, a rectangle, a circle, a star, and the like. The shape of the mask may later be used to demarcate the location of an identified occluded vessel. The mask may be applied without overlapping previously applied masks, or with some overlap with the previously applied mask.

At 348, a corresponding image depicting the vessel of the first image without the blockage may be accessed, for example, as described with reference to 304 of FIG. 3A. The corresponding image may be an aggregated image, computed as described with reference to 206 of FIG. 2.

At 350, a record is created. The record includes the first image (e.g., aggregated image) with an applied instance(s) of the mask(s) to one or more different regions of the first image, and the corresponding image (e.g., aggregated image).

The corresponding image represents a ground truth for comparing with a reconstruction of the first image that excludes the blockage of the first image.

The mask is not applied to the corresponding image serving as ground truth.

At 352, a training dataset of multiple records of multiple sample images (e.g., aggregated images) of multiple sample subjects may be created by iterating features described with reference to 342-350, for example, as described with reference to 310 of FIG. 3A.

Each iteration creates a record of a different pair of first image with mask applied to a different location of the first image, and corresponding image used as ground truth.

It is noted that for each pair of first image and corresponding image of a certain subject, multiple records may be created by iteratively moving the mask to different locations on the first image. The same corresponding image may be used as ground truth. Alternatively, a record may include multiple different instances of the same first image with the mask applied to different locations, and a common ground truth of the corresponding image.

At 354, the anomaly ML model may be trained on the training dataset.

The anomaly ML model may be trained using transfer learning and/or domain shift approaches, on at least one other pre-trained ML model which was trained on other sample fluoroscopy images such as other diagnostic images and/or images depicting adverse events.

The anomaly ML model may be implemented as, for example, a neural network, optionally a deep network, such a Unet neural network.

The anomaly ML model may be trained by inputting the first image (i.e., without occlusion) with applied mask(s) and generating a corresponding reconstructed image that excludes the occlusion, i.e., depicting the full level of the vessel which is occluded in the first image. A difference score between the reconstructed image outcome of the anomaly ML model and the corresponding image (that excluded the applied mask) may be computed. The difference score may be computed for the region(s) corresponding to the applied mask(s). The difference score may be computed between the region(s) with applied mask of the first image and corresponding region(s) (without applied mask) of the corresponding image.

The difference score may be back propagated within the anomaly ML model. The anomaly ML model is trained for generating the reconstructed image while minimizing the difference score.

The difference score may be, for example, a L2 difference score.

At least some embodiments described herein are directed towards anomaly detection. Optionally, anomaly detection is done in two phases. The technical problem of detecting occlusions may be formulated as an anomaly detection problem. Considering a scan (i.e., image) of un-occluded blood flow, blood flow is often seen throughout the entire scan. An occluded vessel may be looked upon as an anomaly. That is, corresponding images may be used as in-distribution examples while the first images will be those who contain anomalies.

In the training phase, an input image of non-occlusive (e.g., “healthy” and/or excluding other pathologies) may be quantified into to a number (e.g., 3, 7 or other number) of colors with multiple masks (e.g., random and/or white squares optionally of fixed size). A ML model designed to detect anomalies (referred to herein as an anomaly ML model) is trained to reconstruct the original unmasked squares, by feeding the masked brain image to the model and propagating back the L2 difference (or other difference metric) between the output of the anomaly ML model and the original unmasked brain image.

In the inference phase, a brain image (simulating a “real-time” image) is fed to the trained anomaly ML model, quantified to the number (e.g., 7 or other value) of colors, and iteration over it are performed. In each iteration, one mask (or two or more masks) for example one fixed square, is applied to the input image. The masked image is fed into the trained anomaly ML model, which generates an outcome of a reconstructed region corresponding to the mask (e.g., square). The difference between the (e.g., mean) of the reconstructed masked region (e.g., square) and the original unmasked region (e.g., square) is computed. The regions (e.g., squares) that produced the highest difference (or above a threshold) are marked as the regions of interest.

Referring now back to FIG. 4A, at 402, an input image (e.g., the image described with reference to 204 of FIG. 2) is fed into the ML model for identification of the adverse event. The input image may depict blood vessels of a tissue of a subject. The input image may be an x-ray depicting blood vessels of the brain.

The input image may be an aggregated image (e.g., computed as described with reference to 206 of FIG. 2). Alternatively, the input image may be a single image, such as a single DSA image.

At 404, a likelihood of the input image depicting one or more adverse events (e.g., occluded blood vessels) is obtained as an outcome of the ML model for identification of the adverse event.

Optionally, the likelihood of the input image depicting the occluded blood vessel (or other adverse event) is obtained as a classification category outcome of the ML model for identification of the adverse event. The classification category may be, for example, obstructed and non-obstructed, adverse event and no adverse event, and the like.

At 406, in response to the ML model for identification of the adverse event generating an indication of an adverse event (e.g., occluded vessel) being present in the input image, the location of the adverse event within the input image may be computed.

The location of the blocked vessel may be computed by applying an interpretability model to the ML model for identification of the adverse event for computing contribution of single pixels or groups of pixels of the input image towards the outcome. The interpretability model may be, for example, based on the Deep Lift approach.

A heatmap indicating locations likely depicting the occluded blood vessel(s) may be generated by visually representing the contribution of pixels of the input image. For example, different ranges of values of contribution of pixels may be represents by different colors.

Referring now back to FIG. 11, an exemplary ML model for identification of the adverse event 1102 for classifying an input image 1104 or multiple sequential input images and generating a heatmap 1106, is depicted.

Referring now back to FIG. 12, examples of input images 1202A-D fed into the ML model for identification of the adverse event for classification of input images and heatmap outcomes 1204A-D generated based on the ML model for identification of the adverse event, are presented.

Referring now back to FIG. 4B, at 422, an input image (e.g., the image described with reference to 204 of FIG. 2) is fed into the reconstruction ML model. The input image may depict blood vessels of a tissue of a subject. The input image may be an x-ray depicting blood vessels of the brain.

The input image may be an aggregated image (e.g., computed as described with reference to 206 of FIG. 2). Alternatively, the input image may be a single image, such as a single DSA image.

At 424, a reconstructed image is obtained as an outcome of the reconstruction ML model. When the input image depicts an adverse event such as a blocked blood vessel, the reconstructed image is generated to depict the input image without the adverse events, such as depicting the blood vessel being opened. The reconstruction ML model creates the reconstructed image depicting what the blood vessel (which is presented blocked) is predicted to look like after the blockage is removed.

At 426, a difference score between the reconstructed image and the input image may be computed. The difference score may be computed for the reconstructed image and the input image as a whole. Alternatively or alternatively, a respective difference score may be computed for each region of the input image and corresponding region of the reconstructed image. For example, by dividing the area of the images depicting tissue and/or blood vessels into a grid, and computing the difference score for each square of the grid.

The difference score may be computed, for example, as a difference in pixel intensity values.

At 428, the occlusion of the blood vessel may be identified when the difference score meets a requirement, for example, is above a threshold. The threshold may be selected to indicate a significant difference, for example, between dark pixel values indicating no blockage, and light pixel values indicating blockage.

Optionally, for the case of multiple different scores computed for different regions of the images, a location of the occlusion may be identified at a certain region when the difference score for the certain region meets the requirement, for example, is above the threshold.

At 430, a heatmap may be generated by visually representing different difference scores for the different regions. For example, different ranges of difference scores are represented by different colors.

Referring now back to FIG. 13, an exemplary flow 1302 for reconstructing of an image 1304 depicting a non-occluded vasculature from an input image 1306 depicting an occluded vasculature using a reconstruction ML model 1308, is presented. A heatmap 1310 may be generated based on computed differences scores between regions of image 1304 and image 1306.

Referring now back to FIG. 4C, at 442, the input image may be processed, optionally by quantizing the input image into multiple colors, for example, as described with reference to 342 of FIG. 3C.

The input image may be an aggregated image (e.g., computed as described with reference to 206 of FIG. 2). Alternatively, the input image may be a single image, such as a single DSA image.

At 444, one or more masks are applied to one or more regions of the (optionally pre-processed) input image.

At 446, the input image with applied mask(s) is fed into the anomaly ML model.

At 448, a reconstruction of the input image is obtained as an outcome of the anomaly ML Model. The reconstructed image includes a reconstruction of the marked region(s) of the input image.

At 450, a difference score between the reconstructed region(s) of the reconstructed image and the corresponding region of the input image(s) without the applied mask, is computed.

At 452, features described with reference to 444-450 may be iterated.

In each iteration, the mask(s) may be applied to a different region(s) of the input image. The iterations may be performed for applying the mask(s) for covering the entire tissue of the input image, for example, the entire area of the image that includes the blood vessels of the brain.

At 454, the location of the occlusion of the blood vessel(s) may be identified as a region corresponding to a certain region when the difference score meets a requirement, for example, above a threshold and/or region having highest difference score.

A boundary box may be drawn for demarcating the region meeting the requirement, thereby indicating the location of the occlusion (or other adverse event).

Referring now back to FIG. 14, an exemplary process 1400 for reconstruction of an unmasked image using the trained anomaly ML model, is depicted. An input image 1402 is obtained, for example, as described with reference to 204 of FIG. 2. The input image is quantized 1404, as described with reference to 442 of FIG. 4C. One or more masks are applied to one or more regions of the input image 1406, as described with reference to 444 of FIG. 4C. The masked input image(s) is fed into the anomaly ML model 1408, as described with reference to 446 of FIG. 4C. A reconstructed image 1410 is obtained as an outcome of the anomy ML model, as described with reference to 448 of FIG. 4C.

Referring now back to FIG. 15, an example of an image 1502 with occluded vessel and an example output of a reconstruction of the image 1504 generated by the anomaly ML model, where square masked regions with high difference scores are marked, is presented.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models and medical images will be developed and the scope of the terms machine learning model and medical image are intended to include all such new technologies a priori.

As used herein the term “about” refers to ±10 %.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A computer implemented method, comprising:
in a plurality of iterations over a plurality of time intervals, in real-time during a catheterization procedure:
accessing a plurality of time-spaced sequential images depicting blood vessels of tissue in at least one contrast state, the plurality of time-spaced sequential images captured over a time interval of the plurality of time intervals and at one or more image planes;
creating an aggregated image by stacking and/or concatenating the plurality of time-spaced sequential images;
feeding an input image comprising the aggregated image into at least one ML model; and
over successive time intervals, monitoring outcome of the at least one ML model for an adverse event that developed in real-time during the catheterization procedure, the outcome including a label indicating a location of at least one blood vessel in which the adverse event occurred.

2. The computer implemented method of claim 1, wherein the adverse event is selected from: occlusion, dissection, and bleeding.

3. The computer implemented method of claim 1, further comprising computing a navigation route from a selected location in a selected blood vessel to a location of the vessel in which the identified adverse event occurred.

4. The computer implemented method of claim 1, further comprising registering the input image and/or an anatomical image of the plurality of time-spaced sequential images of the aggregated image in which the adverse event was identified with a reference image indicating function of tissue, and determining function likely impacted by the adverse event of the identified vessel by mapping the location of the adverse event of the image to the reference image.

5. The computer implemented method of claim 1, wherein the at least one contrast state includes during which the plurality of time-spaced sequential images are captured include: arterial phase, parenchyma phase, and venous phase.

6. The computer implemented method of claim 5, wherein the plurality of time-spaced sequential images include images sampled from frames of a video captured during each of the arterial phase, parenchyma phase, and venous phase.

7. The computer implemented method of claim 1, wherein the at least one contrast state comprises a plurality of contrast states,
wherein the plurality of time-spaced images include at least one representative image sampled from each of a plurality of contrast states;
wherein creating comprises creating the aggregated image by concatenating and/or stacking the at least one representative image sampled from each of a plurality of contrast states for creating a multi-channel image,
wherein the input image comprises the multi-channel image.

8. The computer implemented method of claim 1,
wherein the plurality of time-spaced sequential images are captured over a plurality of different image planes defined by different orientations of an image sensor,
wherein the plurality of time-spaced images include at least one representative image sampled from each of the plurality of different image planes,
wherein creating comprises creating the aggregated image by concatenating and/or stacking the at least one representative image sampled from each of the plurality of different image planes for creating a multi-channel image,
wherein the input image comprises the multi-channel image.

9. The computer implemented method of claim 1,
further comprising selecting at least two consecutive images of the plurality of time-spaced sequential images;
wherein creating comprises creating the aggregated image by concatenating and/or stacking the at least two consecutive images for creating a multi-dimensional image,
wherein the input image comprises the multi-dimensional image.

10. The computer implemented method of claim 9,
further comprising selecting at least two consecutive images of the plurality of time-spaced sequential images;
wherein creating comprises segmenting each of the at least two consecutive images to obtain at least two segmented images, and averaging the at least two segmented images to obtain a single averaged segmented image,
wherein the input image comprises the single averaged segmented image.

11. The computer implemented method of claim 1,
wherein the ML model is trained on a training dataset comprising a plurality of records of a plurality of subject, each record including a pair of training images including a first image depicting tissue of a subject including at least one occluded blood vessel and a second image depicting the tissue of the subject wherein the at least one occluded blood vessel of the first image is non-occluded,
wherein the first image and the corresponding image of each record comprise a respective aggregated image created by concatenating and/or stacking time-spaced sequential images.

12. The computer implemented method of claim 1, further comprising applying an interpretability model to the at least one ML model for computing contribution of single pixels or groups of pixels of the input image towards the outcome, and generating a heatmap indicating locations likely depicting at least one occluded blood vessel by visually representing the contribution of pixels of the input image.

13. The computer implemented method of claim 1,
wherein the at least one ML model comprises a reconstruction ML model, and
wherein feeding comprises feeding the input image into the reconstruction ML model, and further comprising:
obtaining a reconstructed image as an outcome of the reconstruction ML model;
computing a difference score between the reconstructed image and the input image; and
identifying an occlusion of the at least one blood vessel when the difference score is above a threshold,
wherein the reconstruction ML model is trained on a training dataset comprising a training dataset comprising a plurality of records of a plurality of subject, each record including a first image depicting tissue of a subject including at least one occluded blood vessel and ground truth label of a corresponding image depicting the tissue wherein the at least one occluded blood vessel of the first image is non-occluded,
wherein the first image and the corresponding image of each record comprise a respective aggregated image created by concatenating and/or stacking time-spaced sequential images;
computing the difference score for each of a plurality of regions of the input image, and identifying a location of the occlusion at a certain region when the difference score for the certain region is above the threshold; and
generating a heatmap by visually representing different scores for the plurality of regions.

14-16. (canceled)

17. The computer implemented method of claim 1,
wherein the at least one ML model comprises an anomaly ML model,
and further comprising for each input image generated for each iteration of the plurality of iterations:
quantifying the input image into a plurality of colors;
applying at least one mask to at least one region of the input image into the anomaly ML model;
wherein feeding comprises feeding the input image with applied at least one mask into the anomaly ML model;
obtaining a reconstruction of the input image including at least one region corresponding to the at least one region of the input image to which the at least one mask is applied;
computing a difference score between the at least one region of the reconstructed image and the corresponding at least one region of the input image without the applied at least one mask,
wherein in each iteration the at least one mask is applied to a different at least one region of the input image,
wherein the iterations are performed for applying the at least one mask for covering the tissue of the input image; and
identifying the location of the occlusion of the at least one blood vessel as a region corresponding to the at least one region when the difference score is above a threshold and/or for the at least one region having highest difference score.

18. The computer implemented method of claim 17, wherein the anomaly ML model is trained on a training dataset comprising a plurality of records of a plurality of subjects, each record including a first image depicting tissue of a subject including at least one occluded blood vessel, to which at least one mask is iteratively applied to different regions of the first image, and a ground truth label of a corresponding image depicting the tissue of the subject where the at least one occluded blood vessel of the first image is non-occluded,
wherein the first image and the corresponding image of each record comprise a respective aggregated image created by concatenating and/or stacking time-spaced sequential images,
wherein the images in the training dataset are quantified into a plurality of colors.

19-21. (canceled)

22. The computer implemented method of claim 1, wherein the tissue is selected from: brain, heart, lungs, liver, limbs, and digestive system, the input image is an angiographic image with contrast introduced into vasculature and the at least one blood vessel comprises a blood vessel of the at least one of: brain, heart, lungs, liver, limbs, and digestive system.

23. The computer implemented method of claim 1, wherein the aggregated image includes a plurality of colors, each color denoting a different contrast phase.

24. The computer implemented method of claim 1, wherein the adverse event comprises occlusion of a blood vessel, and further comprising treating the subject by opening the identified occluded vessel, wherein the treatment for opening the identified occluded vessel comprises mechanical removal of an embolism and/or injection of an agent for dissolving the embolism.

25-39. (canceled)

40. The computer implemented method of claim 1, wherein the plurality of time-spaced sequential images include 2D fluoroscopy images captured in real-time during the catheterization procedure.

41. The computer implemented method of claim 1, wherein the at least one ML model is trained using transfer learning and/or domain shift approaches, on at least one other pre-trained ML model which was trained on other sample images including other diagnostic images and/or images depicting adverse events.
